(19) United States
(12) Patent Application Publication
(10) Pub. No.: US 2026/0138265 A1
(43) Pub. Date: May 21, 2026

(54) LIFT ASSIST EXOSKELETON

(71) Applicant: Advanced Biomechanical Solutions, LLC, Wilmington, DE (US)

(72) Inventors: Simon Kudernatsch, Wilmington, DE (US); David Schmidt, Wilmington, DE (US); Stefan Mayer, Wilmington, DE (US)

(21) Appl. No.: 18/949,162

(22) Filed: Nov. 15, 2024

(51) Int. Cl. B25J 9/00; A61H 1/02

(52) U.S. Cl. CPC B25J 9/0006; A61H 1/0274

(57) ABSTRACT

Disclosed is an exoskeleton to support the upper extremity during manual material and tool handling tasks. This device aims to reduce the risk of musculoskeletal injuries by reducing the user's effort needed to perform common occupational tasks. The device decouples the handled load/material from the upper extremity by incorporating a bilateral cable system attached to an actuator on one end and an end-effector interfacing with handled load/tool and user's hand on the other. The user controls the device through the end-effector user interface which offers manual and automatic operation modes, with built-in sensors for regulating lifting, lowering, and holding functions. The system is capable of handling 50 lbs per side using geared DC-motors and battery-prolonging braking mechanism. Exchangeable end-effectors allow customization of the handled material/tool interface for a variety of tasks. The exoskeleton system itself can be separated from the backpack harness, allowing for further interchangeability and user-specific customization.

### FIELD OF THE INVENTION

This invention is directed to daily work activity support devices and, in particular, to an exoskeleton to support the upper extremity during manual material and tool handling tasks.

### BACKGROUND OF THE INVENTION

In the past several years, the use of exoskeleton devices for occupational applications has been widely implemented in various industries, including automotive, aerospace, construction, nursing, surgery, and dentistry. The purpose of these devices is to assist laborers in a complementary manner—not necessarily enhancing their abilities, but rather providing support that reduces the effort needed to perform daily work activities. The ultimate desired effect is to prevent musculoskeletal injuries and keep the workforce healthier.

### SUMMARY OF THE INVENTION

The device presented here is aimed at providing complementary support to the entire upper extremity (including the wrist, elbow, and shoulder) during manual material and tool handling operations. In this device, the handled material/load is coupled to the frame of the user-worn device through a flexible cable attached bilaterally to an end-effector on one end and a cable actuation system on the other. This routing decouples the wrist, elbow, and shoulder from the handled material/load, thus reducing the effort required for operation. The instrumented end-effectors, placed in the palm of the user's hand, connect wirelessly to the exoskeleton system electronics and control effect or the behavior of the cable actuation system.

Two modes of user operation are available: manual and automatic. In the manual mode, the user utilizes two force-sensitive buttons on each end-effector, where the amount of force exerted on each button corresponds to changes in lifting or lowering speed or represents a holding command. In the automatic mode, the end-effector utilizes separate built-in force sensors to sense the weight of the handled material/load and the amount of force applied to it by the user. The relationship between the three variables (weight of the handled material/load, amount of force applied by the user, and the exerted force from the exoskeleton system) determines the lifting/lowering speed or material/load holding state.

The battery-powered cable actuation system provides the ability to lift up to 50 lbs per side by using geared DC motors. To prolong battery life and enhance safety, the actuation system features a servo-activated braking mechanism in series with the geared DC motors. The braking mechanism is used in holding and lowering modes only, where virtually no power is consumed by the main geared DC motor.

The entire device comprises two main subsystems: the exoskeleton system and the backpack harness. Whereas the exoskeleton system is a unique device and premise of this invention, the backpack harness, including the fabric straps (not depicted in this invention), can be sourced from various manufacturers. The exoskeleton system is purposefully designed to be independent of the backpack harness to make the system exchangeable and modular for this and future iterations. Modularity and user hygiene are major advantages of this approach, where each user can have a personal backpack harness while the exoskeleton system can be shared between multiple users. This approach also supports using a variety of future exoskeleton systems coupled to the same backpack harness for uses other than manual material and tool handling. Another way to think about this concept is imagining an exoskeleton station, similar to a common industrial tool station, where the user wearing the same harness can easily mount an exoskeleton system most suitable to their upcoming task. In this way, the user can choose which type of exoskeleton to use for which application and when without having to don or doff the backpack harness itself. Additionally, the end-effectors are designed to be easily exchangeable for a new set of end-effectors more suitable to applications other than manual material and tool handling.

In summary, the invention represents a novel exoskeleton device capable of supporting the entire upper extremity, including the shoulder, elbow, and wrist, while introducing a modular approach to exoskeleton applications by separating the exoskeleton system from the backpack harness system worn by the user.

Known prior art includes Patent Registrations: CN107847389B: Exoskeleton communication and control method; CN107835675B: Method and apparatus for a human arm supporting exoskeleton; U.S. Pat. No. 10,786,896B2: Arm supporting exoskeleton with a variable force generator; U.S. Pat. No. 10,442,078B2: Exoskeleton and method of using the same; EP2961575B1: Modular exoskeletal force feedback controller; JP7340522B2: Exoskeleton rehabilitation support device; JP6112567B2: Exoskeleton; U.S. Pat. No. 11,033,449B2: Upper-body robotic exoskeleton; U.S. Pat. No. 10,569,413B2: Exoskeleton and method of providing an assistive torque to an arm of a wearer; U.S. Pat. No. 7,862,524B2: Portable arm exoskeleton for shoulder rehabilitation; ES2690989T3: Exoskeleton and method to provide a pair of assistance to a user's arm; CN110678156B: Coupling system for an exoskeleton; CN106924013B: Exoskeleton type upper limb rehabilitation training robot; U.S. Pat. No. 5,437,609: Chiropractic articulating traction chair; U.S. Pat. No. 11,787,040B2: Modular exoskeleton structure that provides force assistance to the user; CN105662783B: Exoskeleton type upper limb rehabilitation training robot; JP6889187B2: Flexible exoskeleton suit to assist human movement; CN107374907B: Wearable upper limb exoskeleton rehabilitation device; U.S. Pat. No. 10,420,695B2: Exoskeleton apparatus driven by pneumatic artificial muscle with functions of upper limb assist and rehabilitation training; CN104873360B: A kind of upper limb healing exoskeleton robot driving based on lasso trick; U.S. Pat. No. 9,504,623B2: Exoskeleton load handling system and method of use; CN108500957B: Wearable flexible upper limb exoskeleton assistance system; U.S. Pat. No. 8,968,222B2: Wearable material handling system; CN110868964B: Exoskeleton, orthosis, wearable device or mobile robot using magnetorheological fluid clutch apparatus; KR101953324B1: Shoulder module for exoskeleton structures; U.S. Pat. No. 10,864,102B2: Human interface device for exoskeleton apparatus; CN205586208U: Ectoskeleton robot; CN109571435B: Shoulder assistance lifting exoskeleton; US20230201065A1: Human interface device for exoskeleton apparatus; US20180110669A1: Non-invasive mechatronic device providing joint mobility; CN112372625A: Shoulder joint power-assisted passive exoskeleton robot; WO2020125071A1: Wearable shoulder-assisted exoskeleton capable of improving comfort; CN111571568A: Exoskeleton device; CN114714325A: Upper limb assistance exoskeleton and exoskeleton device capable of assisting in carrying.

The prior patents use basic spring mechanics, motor activation, piston-damper mechanics, or a combination of two or all three to either rehabilitate or provide a type of dynamic lifting movement either passively or actively. Each device is a stand alone device that does not take advantage of the prior modularity of the present invention to customize the backpack harness independent of the lifting mechanism.

An objective of the invention is to afford the ability to integrate with prior exoskeletons without the backpack harness. As an invented entity, the invention affords anthropomorphic upper extremity movements during manual material handling. Many of the prior exoskeletons restrict anthropomorphic upper extremity movements to some extent or only engage in assisting the lift at a certain degree of abduction of the hand-arm complex. All except CN114714325A, which has a similar concept, but without the force sensing and motorized assistive properties. Furthermore, CN114714325A is a whole body exoskeleton that dissipates forces through the ground. As previously stated, the modularity of the invention allows linking with a leg exoskeleton to dissipate larger manual material handling loads of high frequency if desired.

Another objective of the invention is to afford a means to lift medium to smaller loads requiring higher frequency lifts at all angles of abduction of the hand-arm complex. Thus, the market for medium to smaller higher frequency load lifts is vast and ubiquitous.

Other objectives and advantages of this invention will become apparent from the following description taken in conjunction with any accompanying drawings wherein are set forth, by way of illustration and example, certain embodiments of this invention. Any drawings contained herein constitute a part of this specification, include exemplary embodiments of the present invention, and illustrate various objects and features thereof.

### BRIEF DESCRIPTION OF THE DRAWINGS

FIG. 1 is a perspective view showing the full exoskeleton assembled;

FIG. 2A is a top view thereof;

FIG. 2B is a perspective view thereof;

FIG. 2C is a front view thereof;

FIG. 2D is a right side view thereof;

FIG. 3 is a back side view thereof;

FIG. 4 is an exploded view of the Exoskeleton System detached from the Backpack Harness;

FIG. 5A is a perspective view of the Exoskeleton System;

FIG. 5B is a perspective view of the Backpack Harness;

FIG. 6A is a perspective view of Exoskeleton System unmounted from the Backpack Harness;

FIG. 6B is a perspective view of a Backpack Spine Mount (Top);

FIG. 6C is a perspective view of a Backpack Spine Mount (Bottom);

FIG. 6D is a perspective view of the Backpack Harness unmounted;

FIG. 7A is a perspective view of an Exoskeleton System Lower Back sub-assembly;

FIG. 7B is a perspective view of an Exoskeleton System Electronics sub-assembly;

FIG. 7C is a perspective view of an Exoskeleton System Spine and Shoulders sub-assembly;

FIG. 8 is an exploded view of the Backpack Harness;

FIG. 9 is an exploded view of the Exoskeleton System Spine and Shoulders;

FIG. 10A is an exploded view of the Exoskeleton System Electronics;

FIG. 10B is a perspective view showing the mounting location of the Exoskeleton System Electronics;

FIG. 11 is a perspective view of electrical components for the Exoskeleton System;

FIG. 12 is a perspective view of the Exoskeleton System Lower Back;

FIG. 13A is a perspective view of the Exoskeleton System Lower Back;

FIG. 13B is a perspective view of an Actuation System found within the Exoskeleton System Lower Back;

FIG. 13C is a perspective view of the assembly of the Exoskeleton System Lower Back;

FIG. 13D is a perspective view of a spine being attached to the Exoskeleton System Lower Back;

FIG. 14 is an exploded view of a Cable Actuation System;

FIG. 15A is a perspective view of the Exoskeleton System Lower Back highlighting a Brake System;

FIG. 15B is a perspective view of the Braking System;

FIG. 15C is a perspective view of the Exoskeleton System Lower Back assembled;

FIG. 16 is an exploded view of the Braking System;

FIG. 17A is a perspective view of the Exoskeleton System Lower Back highlighting a Right & Left Cable Spool;

FIG. 17B is a perspective view of the Left Cable Spool;

FIG. 17C is a perspective view of the Right Cable Spool;

FIG. 17D is a perspective view of the Exoskeleton System Lower Back highlighting a Planetary Gearbox Output Shaft;

FIG. 18A is an exploded view of the Right & Left Cable Spools;

FIG. 18B is a perspective view of the Exoskeleton System Lower Back highlighting the Planetary Gearbox Output Shaft;

FIG. 19 is an exploded view of the entire Exoskeleton System Lower Back;

FIG. 20A is a perspective front view of a Left End Effector;

FIG. 20B is a perspective side view thereof;

FIG. 21A is an exploded view of the Left End Effector;

FIG. 21B is an exploded view of Button 1 on the Left End Effector;

FIG. 21C is an exploded view of Button 2 on the Left End Effector;

FIG. 21D is an exploded view of a top End Effector Coupler and an End Effector Load Cell 2;

FIG. 21E is an exploded view of an End Effector Load Cell 3 and a bottom End Effector Coupler;

FIG. 22A is a perspective front view of a Right End Effector;

FIG. 22B is a perspective side view thereof;

FIG. 23A is an exploded view of the Right End Effector;

FIG. 23B is an exploded view of Button 1 on the Right End Effector;

FIG. 23C is an exploded view of Button 2 on the Right End Effector;

FIG. 23D is an exploded view of a top End Effector Coupler and an End Effector Load Cell 2;

FIG. 23E is an exploded view of an End Effector Load Cell 3 and a bottom End Effector Coupler;

FIG. 24 is a perspective view of electrical components on the End Effector Electronics;

FIG. 25A is a pictorial representation of a user in the process of lifting a load with assistance from the Exoskeleton System during manual material handling;

FIG. 25B is a pictorial representation of a user holding a load with assistance from the Exoskeleton System during manual material handling;

FIG. 25C is a pictorial representation of a user raising a load with assistance from the Exoskeleton System during manual material handling;

FIG. 26 is a flowchart illustrating a high-level overview of the exoskeleton's components & its connections to the load and user;

FIG. 27 is a flowchart illustrating the internal components of the exoskeleton system & connections to the end-effectors;

FIG. 28 is a flowchart illustrating the internal components for design 1 of the end-effectors & connections to the user and load;

FIG. 29 is a flowchart illustrating the internal components for design 2 of the end-effectors & connections to the user and load;

FIG. 30 is a flowchart illustrating the internal components for design 3 of the end-effectors & connections to the user and load;

FIG. 31 is a flowchart illustrating a general overview of the control modes & shows how each mode can switch between each other;

FIG. 32 is a flowchart illustrating a high-level view of each control mode for designs 1 & 3 and shows the respective conditions to activate each mode;

FIG. 33 is a flowchart illustrating a high-level view of each control mode for designs 2 & 3 using load-cells 1 and 2 & shows the respective conditions to activate each mode;

FIG. 34 is a flowchart illustrating a high-level view of each control mode for designs 2 & 3 using load-cells 2 and 3 & shows the respective conditions to activate each mode;

FIG. 35 is a flowchart illustrating a high-level view of each control mode for designs 2 & 3 using load-cells 1, 2 and 3 & shows the respective conditions to activate each mode;

FIG. 36A is a pictorial depiction showing and defining no load-cell deformation for designs 2 & 3 of the exoskeleton;

FIG. 36B is a pictorial depiction showing and defining positive load-cell deformation for designs 2 & 3 of the exoskeleton;

FIG. 36C is a pictorial depiction showing and defining negative load-cell deformation for designs 2 & 3 of the exoskeleton;

FIG. 37 is a flowchart illustrating the internal components of the exoskeleton system electronics & its electronic connections to the cable actuation system, braking system, and end-effectors;

FIG. 38 is a flowchart illustrating the internal components for design 1 of the end-effector electronics & its electronic connections from the user interface (buttons 1 & 2) to the exoskeleton system electronics;

FIG. 39 is a flowchart illustrating the internal components for design 2 of the end-effector electronics & its electronic connections from the load sensor array to the exoskeleton system electronics;

FIG. 40 is a flowchart illustrating the internal components for design 3 of the end-effector electronics & its electronic connections from the load sensor array and the user interface (buttons 1 & 2) to the exoskeleton system electronics;

FIG. 41 is a flowchart illustrating a high-level view of the code used in designs 1, 2, 3 of the end-effectors & its logical connections from the user interface (buttons 1 & 2) and/or load sensor array to the exoskeleton system electronics;

FIG. 42 is a flowchart illustrating the code of the status checker & updater sequence used in the right & left end-effector code & its logical connections to update the output color of LEDs 1 & 2 in status indicator;

FIG. 43 is a flowchart illustrating a general overview of the user operating modes used in designs 1, 2, 3 of the exoskeleton system code & shows how each mode can switch between each other;

FIG. 44 is a flowchart illustrating a high-level view of the code used in exoskeleton system for manual operation mode in designs 1 and 3 & its logical connections from end-effectors to the calculation of machine state and motor velocity setpoint;

FIG. 45 is a flowchart illustrating a high-level view of the code used in exoskeleton system for automatic operation mode in designs 2 and 3 & its logical connections from end-effectors to the calculation of machine state and motor velocity setpoint;

FIG. 46 is a flowchart illustrating a close-up view of the code of the startup sequence used in the exoskeleton system code & its logical connections to calibrate the right and left BLDC motors;

FIG. 47 is a flowchart illustrating the code of the status checker & updater sequence used in the exoskeleton system code & its logical connections to update the output color of LEDs 1, 2, 3 in status indicator;

FIG. 48 is a flowchart illustrating a general overview of the state machine used in the exoskeleton system code & shows how each state can switch between each other;

FIG. 49 is a flowchart illustrating the code of the active state & its logical connections to run the right or left BLDC motors in accordance with the velocity setpoint;

FIG. 50 is a flowchart illustrating the code of the deactivate state & its logical connections to stop the right or left BLDC motors and maintain motor position; and

FIG. 51 is a flowchart illustrating the code of the idle state & its logical connections to run the right or left servos to apply the brake.

### DETAILED DESCRIPTION OF THE PREFERRED EMBODIMENT

Detailed embodiments of the instant invention are disclosed herein, however, it is to be understood that the disclosed embodiments are merely exemplary of the invention, which may be embodied in various forms. Therefore, specific functional and structural details disclosed herein are not to be interpreted as limiting, but merely as a basis for the claims and as a representation basis for teaching one skilled in the art to variously employ the present invention in virtually any appropriately detailed structure.

The exoskeleton design assists a human user in lifting objects. The targeted individuals for use are those that work in warehouses, factories, etc. type jobs that require manual material handling (MMH). Of course, this exoskeleton can be used in any environment to assist in lifting as well. This exoskeleton is an active exoskeleton consisting of two actuators (one for each arm). This creates an element of simplicity in the design and that is limiting the number of degrees of freedom (DOF) to one per arm. In doing this, it allows the user to freely move their arms during use and specifically targets the lifting operation when doing MMH tasks. One DOF per arm is achievable by taking advantage of a spool cable system using nylon cables encased in Bowden casings. There is another element of simplicity in the design that makes manufacturing the exoskeleton simple. The exoskeleton is made up of a blend of plastic and metal parts. The metal parts are specifically used in certain areas to strengthen the durability of the exoskeleton. The following will discuss the exoskeleton's design starting with the mechanical assembly then transitioning to the electrical/programming logic required to run this device.

All exoskeleton depictions described below and shown in figures exclude fabric strapping that is normally required to secure backpack harness 200 to its wearer. Since the exoskeleton system 198 is designed to easily connect and disconnect from the backpack harness, 200, the invention focuses on the exoskeleton system working mechanism rather than the backpack harness and fabric straps (not shown) themselves.

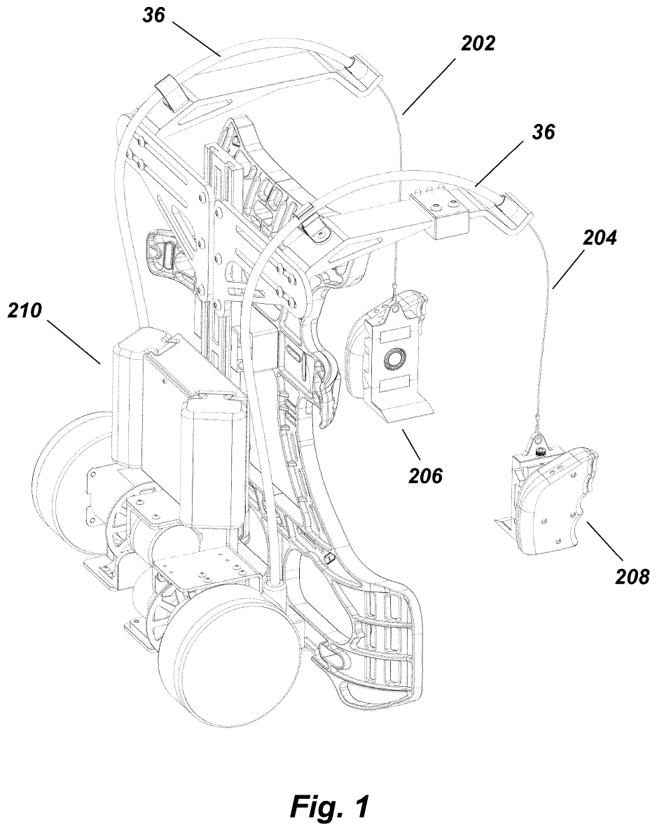

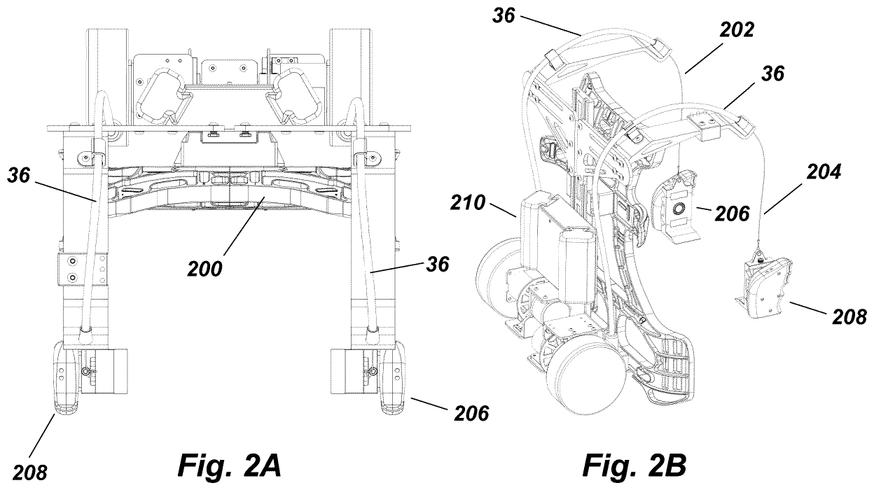

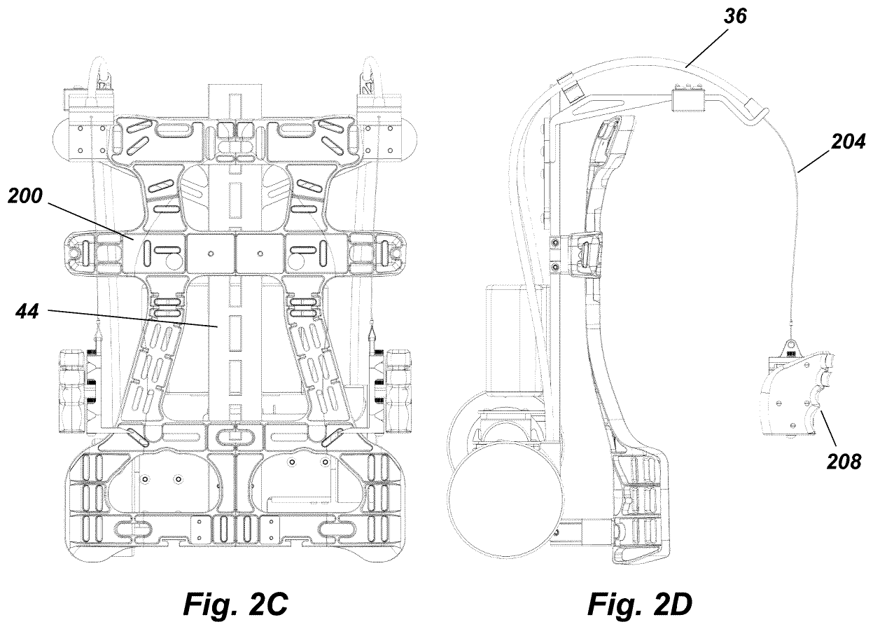

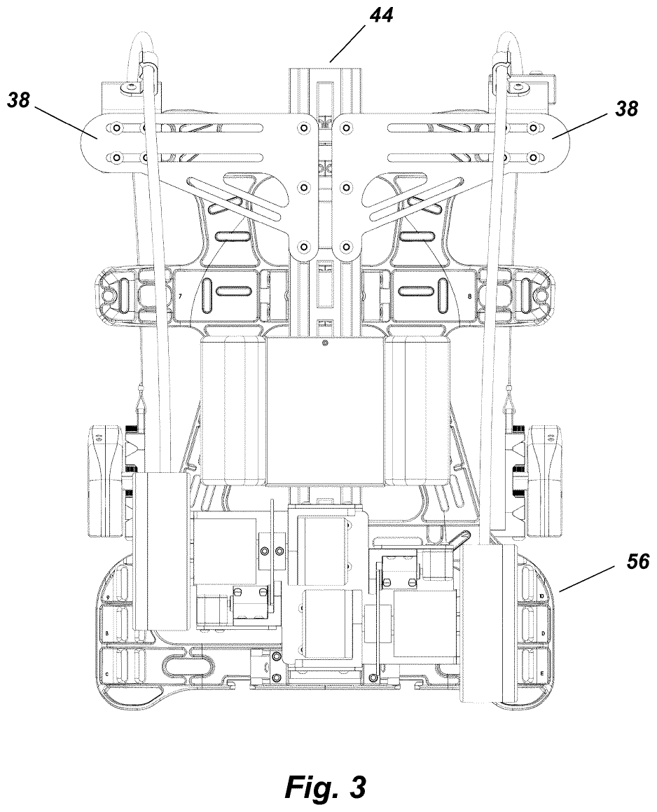

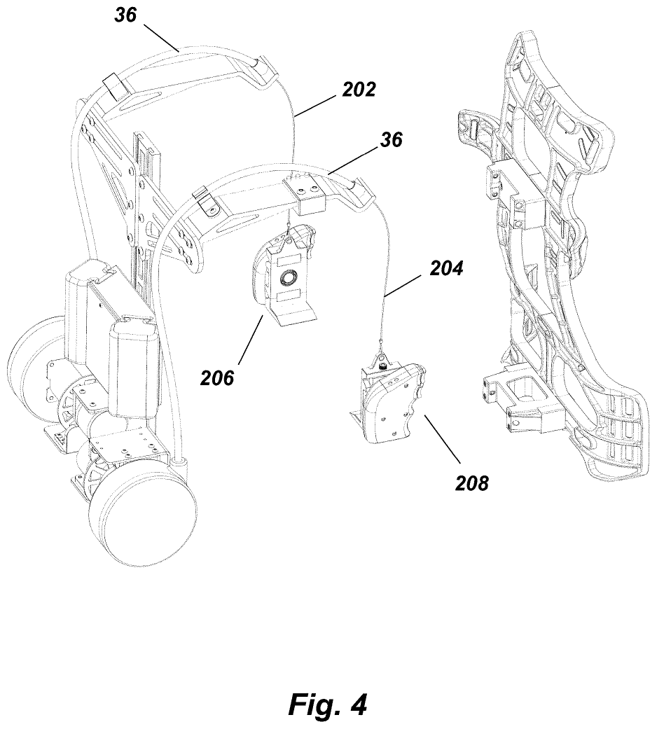

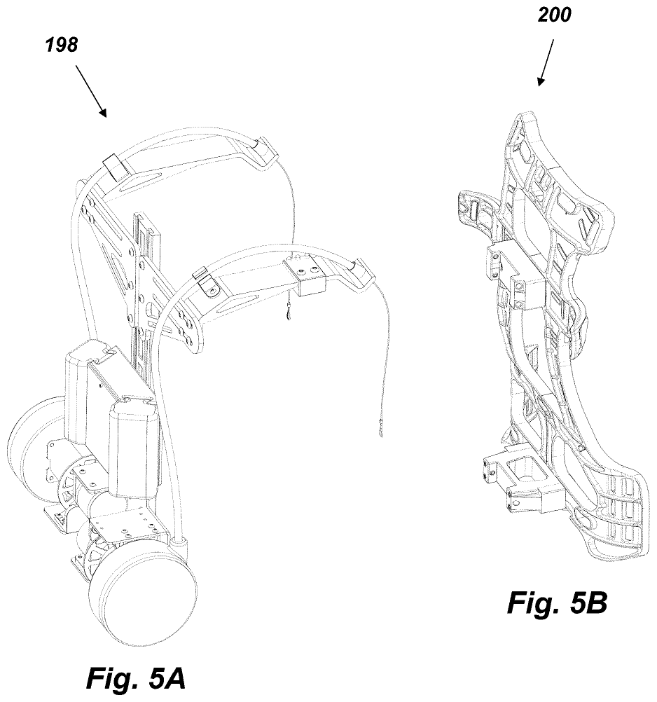

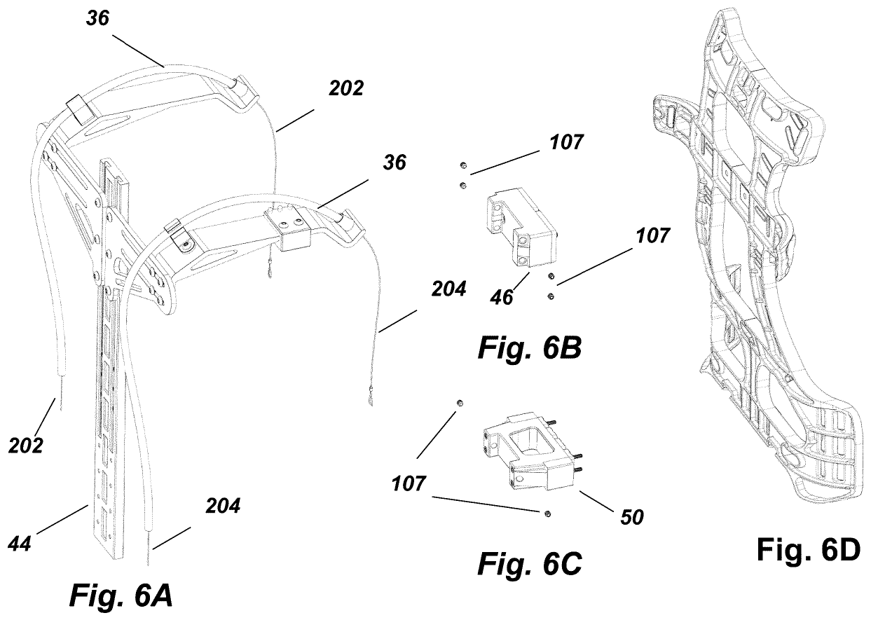

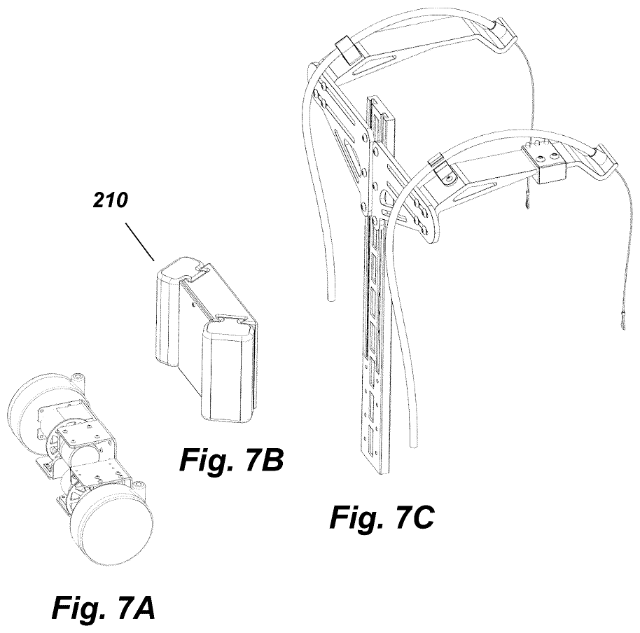

Referring to FIG. 1, it shows an isometric depiction of the full exoskeleton design. Then, in FIGS. 2A-2D, it shows the full isometric design of the exoskeleton including a front, top, and right-side view. Finally, FIG. 3 includes a back view of the exoskeleton which highlights how the entirety of the exoskeleton system 198 comes together. Getting into details on the design, FIG. 4 addresses some key parts used in the final assembly. Bowden casings 36 are shown encasing nylon cables left 202 and right 204. These nylon cables create the connection to the object to be lifted to a spool (will be discussed later) connected to the one actuator in order to lift/lower the object. The last thing to note in FIG. 4 is the two end effectors. The left end effector 206 and the right end effector 208 allow the user to latch onto the desired object to be lifted and held by the exoskeleton. FIGS. 5A and 5B distinguish exoskeleton system 198 from the backpack harness 200. The idea being that if more exoskeleton systems were to be designed in the future, the only thing to be swapped out is the different exoskeleton systems. This way, an individual only needs one backpack harness 200 in order to operate any exoskeleton system of their choice. For the purposes of this patent, only one exoskeleton system 198 has been designed as depicted in FIG. 5A. The end effectors (206 and 208) are not included in the exoskeleton system as the idea is that those could be customizable depending on the payload a user would be lifting or depending on the function of the exoskeleton system. Referring to FIGS. 6A-6D, it shows how the exoskeleton system 198 mounts to the backpack harness 200. The screw configuration including set screws 107 are threaded in the backpack spine mount (top) 46 and backpack spine mount (bottom) 50 in order to hold these to the spine 44. Then, the backpack spine mount (top) 46 and backpack spine mount (bottom) 50 mount to the backpack harness allowing the exoskeleton system 198 to be mounted to the backpack harness 200. Bowden casings 36 and nylon cables for the left 202 and right 204 are again shown this time to show that the nylon cables run throughout the entirety of Bowden casings 36. Referring to FIGS. 7A-7C, the exoskeleton system 198, is shown being split up into three sub-assemblies that include the exoskeleton system lower back, exoskeleton system electronics, and the exoskeleton system spine and shoulders.

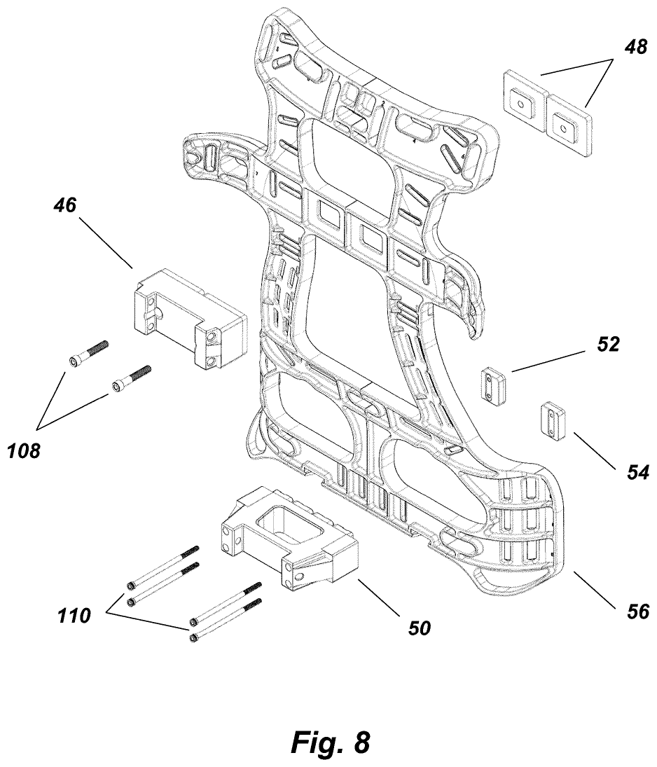

Referring to FIG. 8, it shows an exploded view of the backpack harness 200. All parts mount to the backpack frame 56 which is just a standard military backpack frame used for modeling the design of the exoskeleton. Of course, backpack padding and straps would be attached to the backpack frame 56, however, for modeling purposes, these features were avoided. The backpack spine mount (top) 46 inserts into the corresponding shape from the back of the backpack frame 56. Screw configuration upper spine mount to backpack 108 is used to fasten backpack spine mount (top) 46, backpack frame 56, and backpack mount (top) 48 together. Backpack mount (top) 48 insert into its corresponding shapes from the front of the backpack frame 56 and includes two threaded holes for screw configuration 108 to be screwed to. Screws from screw configuration 108 are countersunk into the backpack spine mount (top) 46 in order to avoid collision with the spine 44 when the exoskeleton system 198 is mounted to the backpack harness 200. Similarly, backpack spine mount (bottom) 50 fits into corresponding shapes from the back of the backpack frame 56. Backpack mounts bottom left 52 and bottom right 54 are inserted into their corresponding shapes from the front of the backpack frame 56. Then, using screw configuration lower spine mount to backpack 110, it fastens the backpack spine mount (bottom) 50, backpack frame 56, and backpack mounts bottom left 52 and bottom right 54 together. Backpack mounts bottom left 52 and bottom right 54 include two threaded holes each to screw the screws from screw configuration 110 in place. Even though the set screws from screw configuration 107 are not shown, they are to be assumed they are embedded inside the backpack spine mount (top) 46 and the backpack spine mount (bottom) 50 awaiting tightening to be fastened to the spine 44.

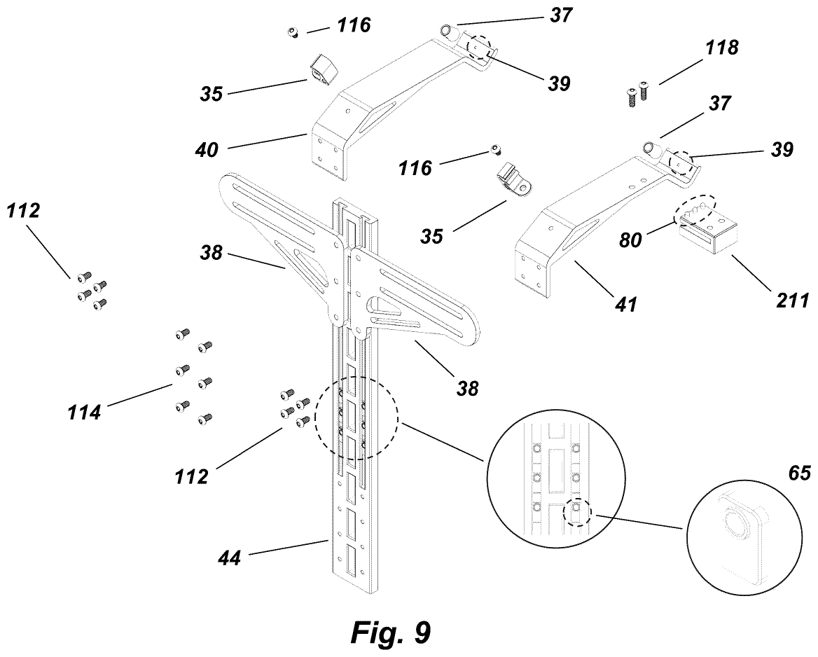

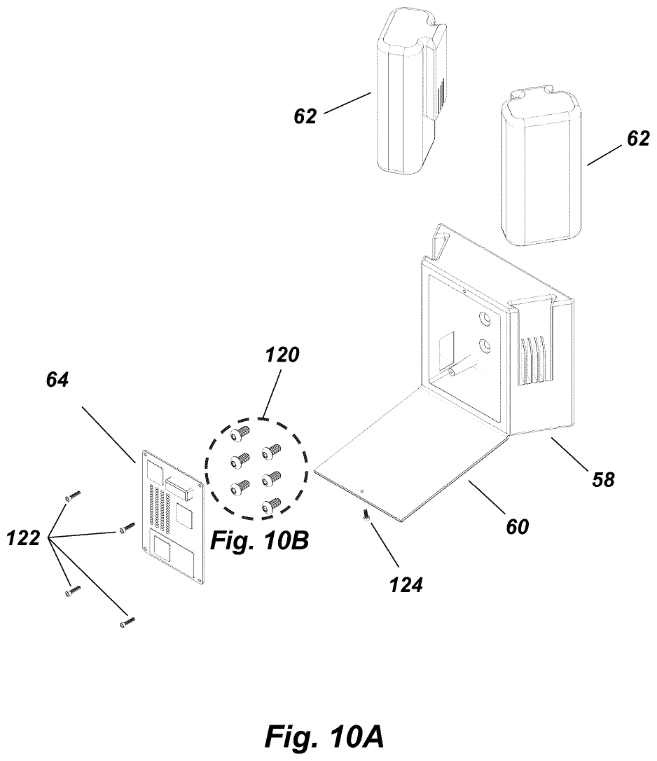

Referring to FIG. 9, it shows an exploded view of the exoskeleton system spine and shoulders sub-assembly without the Bowden casings 36 and nylon cables (202 and 204) shown to prevent clutter. The spine 44 is the centerpiece for this sub-assembly. FIG. 10B shows where the exoskeleton system electronics are mounted. The spine 44 includes two channels that allow the spine utility mount inserts 65 to be slid freely inside of. The spine utility mount inserts 65 which contain a threaded hole are then slid into place and aligned with the electronics box's 58 six holes. Using the screws contained in screw configuration battery/electronics box to spine 120, the electronics box 58 is fastened to the spine utility mount inserts 65. Because of the shape of the channels on the spine 44, the screws from screw configuration 120 pull the electronics box 58 firmly to the spine 44. Referring back to FIG. 9, although not shown, the spine utility mount inserts 65 are also used similarly to fasten the shoulder mount plates 38 to the spine 44 using screw configuration shoulder plate to spine 114. The reason the spine has these channels is to make the exoskeleton adjustable to the user by allowing them to choose where the shoulder height is and where the weight of the exoskeleton system electronics should go. Moving the shoulders higher could also help in specific environments for the user where they would need to lift objects above shoulder level. This would of course mean a longer spine is required which isn't shown in the figures, however, could be implied for customization to the user. Shoulder brackets left 40 and right 41, use screw configuration shoulder plate to shoulder bracket 112 to fasten each shoulder bracket (40 and 41) to the shoulder mount plates 38. These screws from screw configuration 112 are screwed into the shoulder brackets left 40 and right 41 four threaded holes each. Each shoulder bracket is equipped with a Bowden casing clip 35 which is fastened to a threaded hole on the shoulder brackets 40 and 41 using screw configuration Bowden casing clip to shoulder bracket 116. The Bowden casing clip 35 is needed to create a third point of contact to prevent much movement with the Bowden casings 36 to the exoskeleton system 198. One of two ends of the Bowden casing 36 snap-fits to the Bowden shoulder insert 37 in order to center the nylon cable (202 and 204) with shoulder bracket cable hole 39. The shoulder bracket cable hole 39 acts as the output hole to connect to the end effectors 206 and 208. Bowden shoulder insert 37 contains a small shaft with a hole just big enough to fit the nylon cables 202 and 204 through to be press-fit into place using shoulder bracket cable hole 39. This shaft on the Bowden shoulder inserts 37 has a slight expanScrews from screw configuration exoskeleton system electronics board mounting 122 are screwed into the electronics box's 58 four threaded holes to hold the exoskeleton system electronics ding flange in order to prevent the Bowden shoulder insert 37 from slipping out of the shoulder bracket cable hole 39. Finally, the only difference from shoulder bracket left 40 from right 41 is that the shoulder bracket right 41 has two additional holes to mount a status indicator (LED 1, 2, 3) 211 holding three LEDs 80 for the user while using the exoskeleton. This status indicator (LED 1, 2, 3) 211 contains two threaded holes on the bottom half of it that screws from screw configuration shoulder bracket LED display 118 will screw into fastening it to the shoulder bracket right 41.

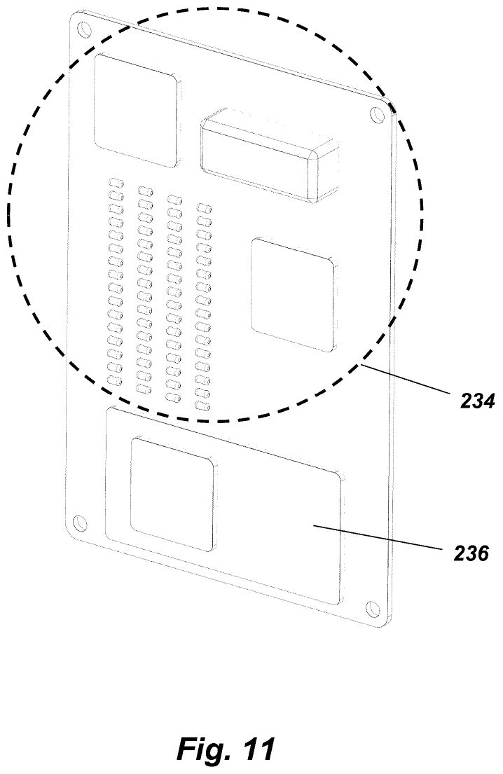

Referring to FIG. 10A, it shows an exploded view of the exoskeleton system electronics sub-assembly. The batteries for the exoskeleton system 62 are shown as slidable fixtures to the electronics box 58. The idea is the same as battery operated power tools such as it acts as a fast and effective way of powering the exoskeleton and to easily recharge the batteries when needed. The electronics box 58 then has holes in the interior to connect power cables from the exoskeleton batteries 62 to the exoskeleton system electronics board 64. Electronics box 58 also contains four extruded posts with threaded holes. board 64 in place. The electronics box 58 is connected to the electronics box cover 60 via hinge to keep the two parts together at all times. The electronics box cover 60 can be swung open/fastened shut by unscrewing/screwing screw configuration battery box cover fastener 124 from the threaded hole on the electronics box 58. Referring to FIG. 11, it shows the two main elements to the exoskeleton system electronics board. These elements include the BLDC motor controller 234 and the microcontroller (exoskeleton system) 236.

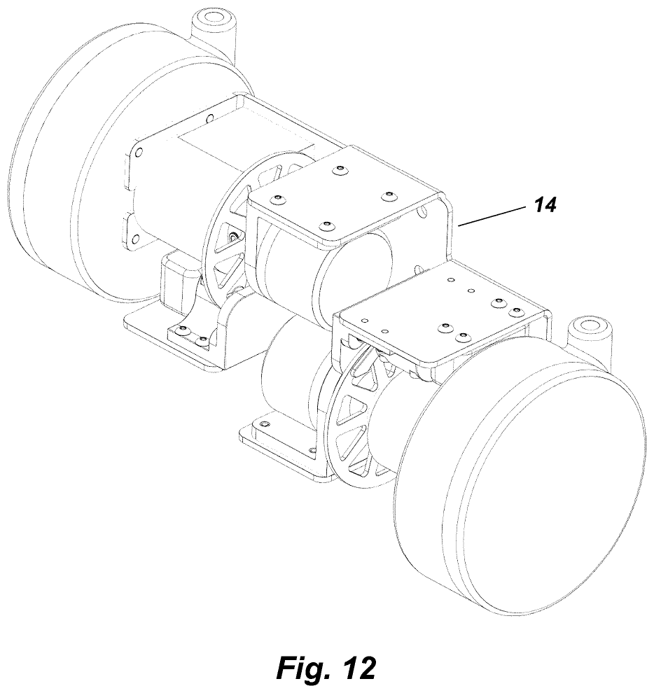

Referring to FIG. 12, it shows the isometric view of the exoskeleton system lower back sub-assembly. The main body of exoskeleton system lower back, exoskeleton lower back body 14, is sheet metal bent precisely to hold various parts. Due to the complexity of these various parts, the exoskeleton system lower back will be split up into three sub-systems, the cable actuation system 212, braking system 214, and right & left cable spools 216.

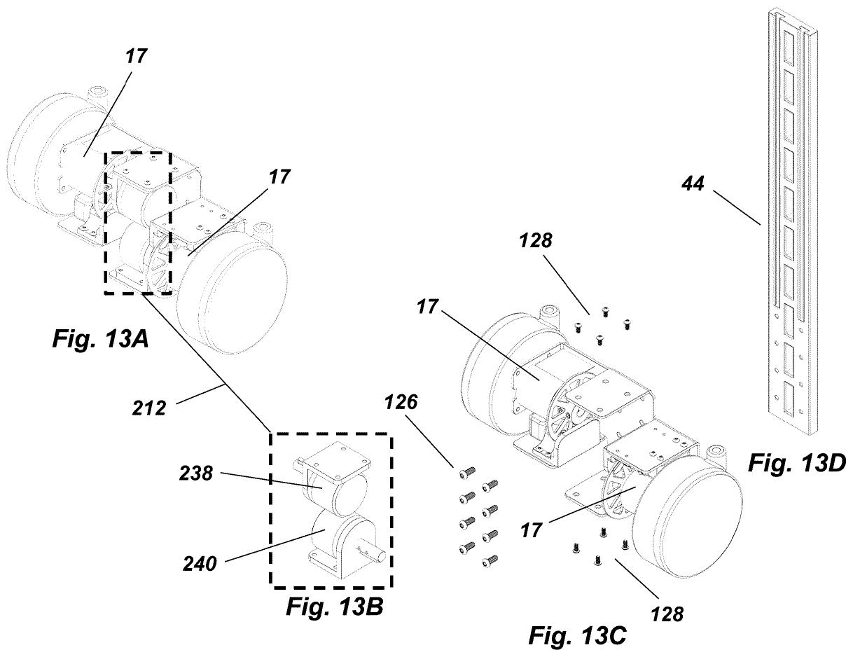

Referring to FIGS. 13A-13D, it highlights where and what the cable actuation system 212 is as well as how the exoskeleton system lower back mounts to the spine 44. Screws from screw configuration exoskeleton lower back body to spine mounting 126 will be inserted through eight free-fit holes on the back side of the exoskeleton lower back body and be screwed into the eight corresponding threaded holes on the spine 44 therefore securing the exoskeleton lower back body 14 to the spine 44. Screws for screw configuration actuator mounts 128 are used to secure the left BLDC motor w/encoder 238 and right BLDC motor w/encoder 240 to the exoskeleton lower back body 14. The left BLDC motor w/encoder 238 and right BLDC motor w/encoder 240 actuators would both be custom to match a similar style shown in FIGS. 13A-13D. The four holes on the flat part of the top/bottom of the left BLDC motor w/encoder 238 and right BLDC motor w/encoder 240 will be threaded to screw in screws from screw configuration 128. Finally, the planetary gearboxes 17 are highlighted to show their position relative to the cable actuation system 212. The planetary gearbox's position will not be important until the braking system 214 is discussed in a later figure.

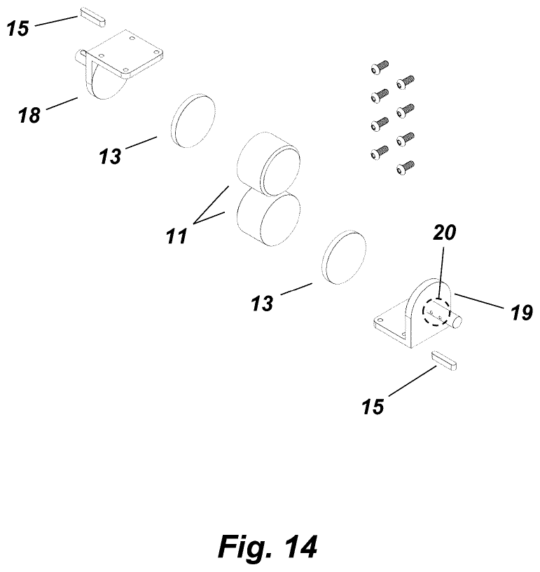

Referring to FIG. 14, it shows an exploded view of the cable actuation system 212. Motor body 11, motor encoder 13, and motor front (left) 18 make up the left BLDC motor w/encoder 238 when these parts are put together. Similarly, motor body 11, motor encoder 13, and motor front (right) 19 make up the right BLDC motor w/encoder 240 when these parts are put together. The motors are stacked on top of one another to minimize the width of the exoskeleton on the user's back therefore making it less likely for the user to collide into obstacles during use. The motor shaft key 15 is used to mount the brake disk 16 for a press-fit in tandem with the threaded screw holes for brake disk 20. The threaded screw holes for brake disk 20 can be found on the shafts of both the left BLDC motor w/encoder 238 (just not visible in FIG. 14) and right BLDC motor w/encoder 240. As to why there are threaded screw holes for the brake disks will be discussed when the braking system 214 is explained. Motor shaft key 15 also serves as the input shaft to the planetary gearbox 17.

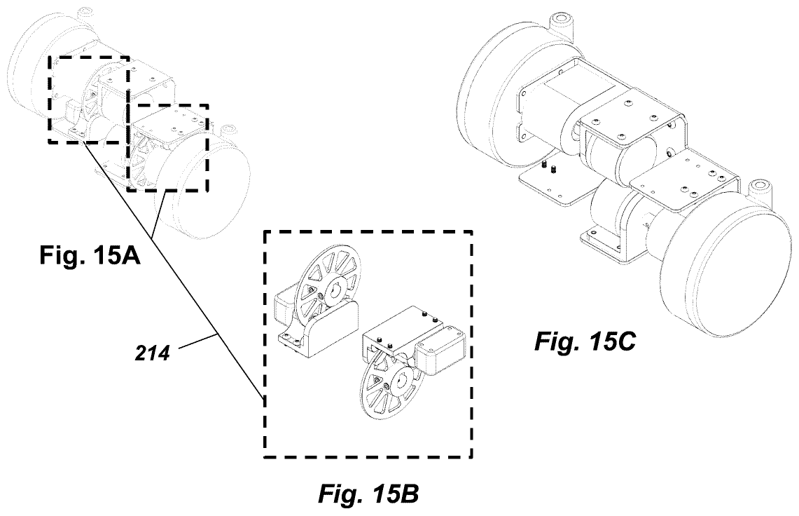

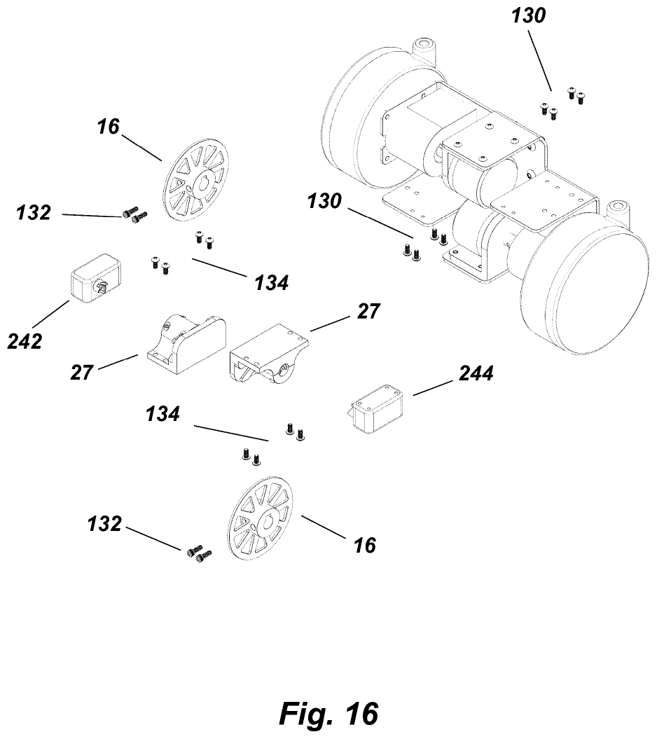

Referring to FIGS. 15A-15C, it highlights the parts included in the braking system 214 as well as where it is located relative to the rest of the exoskeleton system lower back. FIG. 16 then explodes the braking system's 214 parts. The braking parts for the right BLDC motor w/encoder 240 consist of a brake unit 27, screw configurations braking system to exoskeleton lower back body 134, servo to exoskeleton lower back body 130, and brake disk to drive shaft 132, brake disk 16, and right servo (braking system) 244. Similarly, the braking parts for the left BLDC motor w/encoder 238 consist of a brake unit 27, screw configurations braking system to exoskeleton lower back body 134, servo to exoskeleton lower back body 130, and brake disk to drive shaft 132, brake disk 16, and left servo (braking system) 242. Note that the right servo (braking system) 244 and the left servo (braking system) 242 are the same part but just labeled differently for explanation purposes. Using screws from screw configuration 134, the brake unit 27 can be mounted to the exoskeleton lower back body 14 which has threaded holes. Using screws from screw configuration 130, the right servo (braking system) 244 and left servo (braking system) 242 can be mounted to the exoskeleton lower back body 14, the threaded holes are on the servos (242 and 244). The brake unit 27 can move its brake pads forwards and backwards by turning the shafts of the right servo (braking system) 244 or left servo (braking system) 242. When the brake pads are pushed forward, they will rub against the brake disk 16. Depending on how far the brake pads are pushed forward, it will slow the brake disk's 16 rotations down faster the more pressure is applied. If enough pressure is applied, then the brake disk 16 will prevent the left BLDC motor w/encoder 238 or right BLDC motor w/encoder 240 from rotating and cause the exoskeleton to be in a “hold” state. The servos (242 and 244) can then be rotated in a reverse direction to pull the brake pads backwards therefore releasing the brake disk 16 and enabling the left BLDC motor w/encoder 238 or right BLDC motor w/encoder 240 to rotate and lift/lower the corresponding side of the exoskeleton. The brake disks 16 are fastened directly to the actuator's shafts using screws from screw configuration 132. Screws from screw configuration 132 are threaded into the threaded screw holes for brake disk 20 from FIG. 14. Brake disk 16 is screwed to the actuator's shafts directly to ensure the brake disk 16 does not wobble. Planetary gearbox 17 is located after the braking system 214. This is to take advantage of the gear ratio when braking. Servos (242 and 244) do not have the strength to hold objects directly, so by placing the brake system at the actuator's shafts before the planetary gearbox 17, it means that there will be a gear reduced amount of load for the servos (242 and 244) to handle. A much more reasonable load given the size of the servos used. This required load then gets converted to a torque requirement and amount of rotation the servo (242 and 244) must perform to push the brake pads a desired amount forwards or backwards to hold the desired load.

Brake unit 27 from FIG. 16 is not much different from the standard brake system used on bicycles which is why the details will not be shown. The only detail worth mentioning is that brake unit 27 takes advantage of a helical shape to convert rotational motion into translational motion to propel the brake pads forwards and backwards. The channels in the helical shape attached to the servos are used to insert ball bearings to lower the friction of the rotational motion. Finally, to prevent the brake pads from turning, there are guided rails inside brake unit 27 to only extract the translational movement rather than translational and rotational movement from the servo.

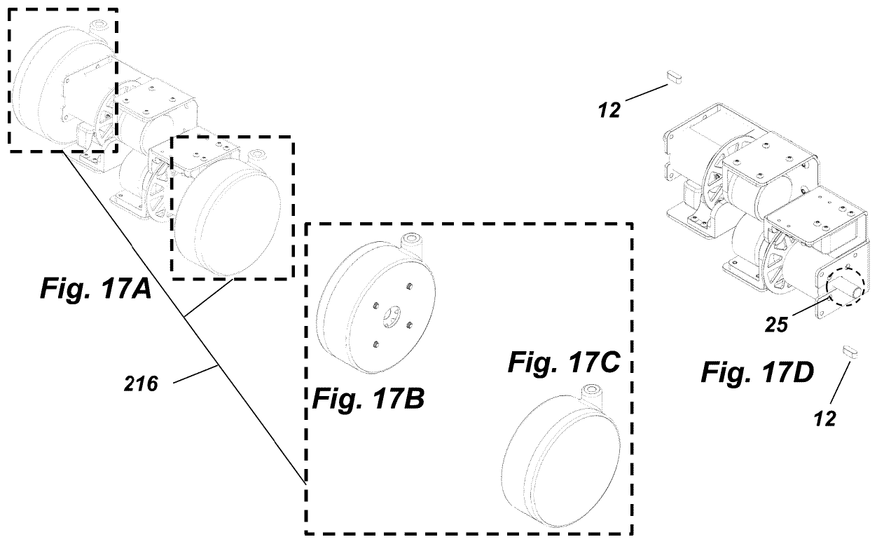

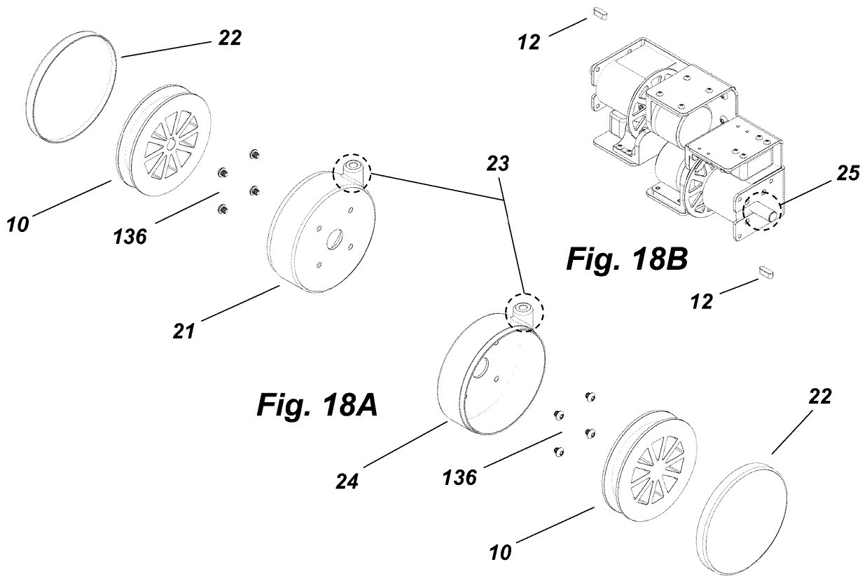

Referring to FIGS. 17A-17D, it highlights the parts included in the right & left cable spools 216 as well as where it is located relative to the rest of the exoskeleton system lower back. The gearbox shaft key 12 is also shown to indicate where the planetary gearbox output shaft 25 of the planetary gearbox 17 is located. Note that it is the same for the left side of the exoskeleton system lower back but just not visible in FIGS. 17A-17D. Referring to FIGS. 18A-18B, it shows an exploded view of the right & left cable spools 216. The right cable spool consists of spool case (right) 24, screws from screw configuration spool case to exoskeleton lower back body 136, spool 10, and spool case twist cap 22. Similarly, the left cable spool consists of spool case (left) 21, screws from screw configuration spool case to exoskeleton lower back body 136, spool 10, and spool case twist cap 22. Spool case (left) 21 and spool case (right) 24 are mounted to the exoskeleton lower back body 14 using screws from screw configuration 136 via four threaded holes on the exoskeleton lower back body 14. The planetary gearbox output shaft 25, gearbox shaft key 12, and spool 10 have a high tolerance so the spool 10 is press-fit onto the planetary gearbox output shaft 25. The spools 10 get rotated by the left BLDC motor w/encoder 238 and right BLDC motor w/encoder 240. The spools 10 house the nylon cables (202 and 204) by winding them up. The cables (202 and 204) are long enough for any reasonable lowering amount of the end effectors (206 and 208) with spare cable for any excess movement to prevent unwinding. When the exoskeleton is lifting, the spools will be rotated in an opposite direction to re-wind the nylon cables (202 and 204) into spool 10. To cap off the cable spools and hide the spool 10, the spool case twist cap 22 can be screwed on the spool case (left) 21 and spool case (right) 24. Therefore, this means that the lip of material seen on spool case (left) 21 and spool case (right) 24 would be threaded to accommodate the spool case twist cap 22. Finally, the Bowden case threaded hole 23 acts as the location for the second end of the Bowden casing 36 to be inserted. This end would be the first to be mounted when assembled so for that reason, the Bowden casing 36 would have a threaded end to screw into the Bowden case threaded hole 23. Bowden case threaded hole 23 is also where the nylon cables (202 and 204) exit the right & left cable spools 216 through the Bowden casings 36 and attach to the end effectors (206 and 208). This is depicted in FIG. 4.

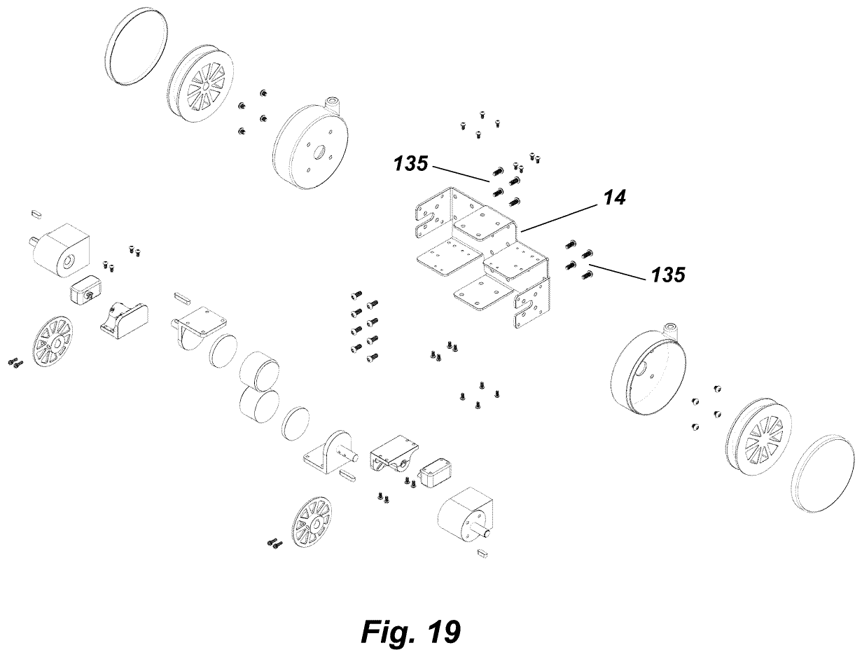

Referring to FIG. 19, it shows a fully exploded view of the exoskeleton system lower back and ties up any loose ends regarding this subassembly. The exoskeleton lower back body 14 is highlighted again and is fully isolated this time to show exactly what this bent sheet metal plate entails. Finally, screws from screw configuration planetary gearbox to exoskeleton lower back body 135 go through four through holes on the exoskeleton lower back body 14 on each side and screw into four threaded holes on the side of each planetary gearbox 17. This then tightly secures the gearbox to the exoskeleton lower back body 14 to ensure that all axes are aligned.

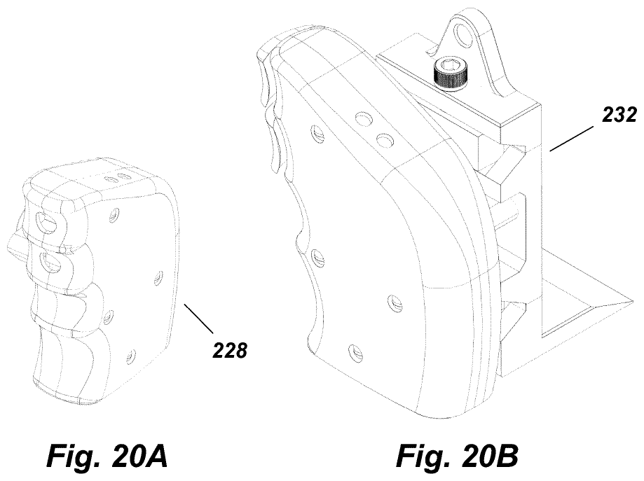

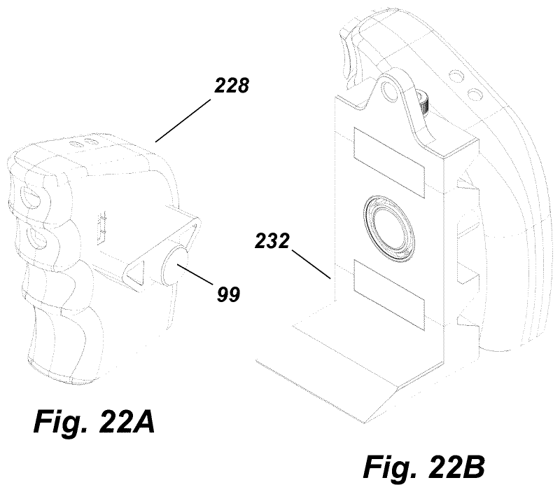

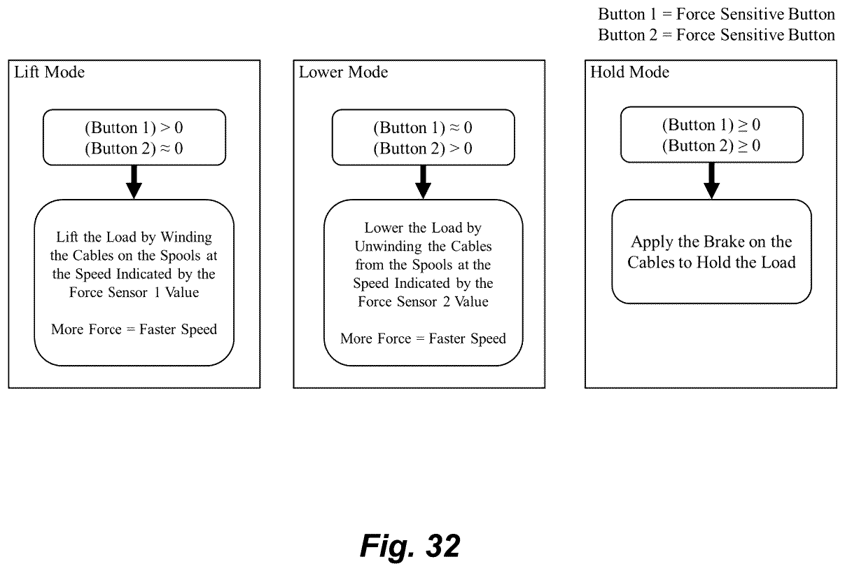

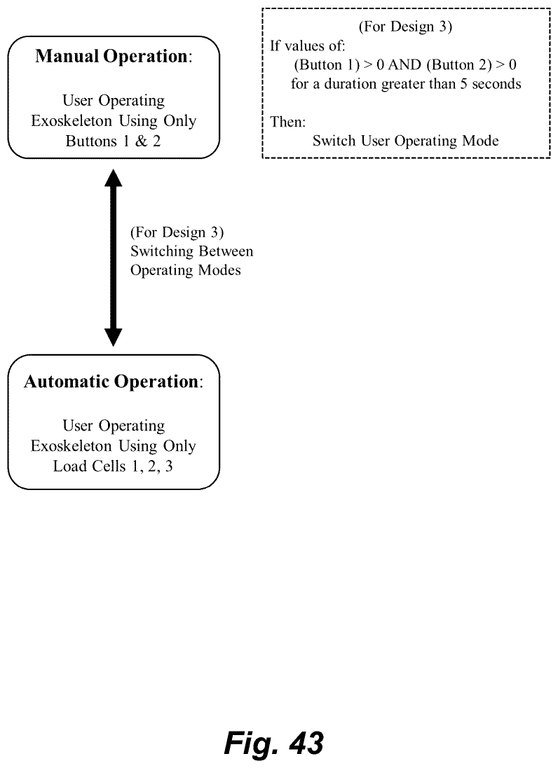

The final subassemblies to discuss are the end effectors (206 and 208). Note that the left end effector 206 is the same as the right end effector 208, but mirrored, so some parts may just be flipped from one another. The mechanical design of the end effectors (206 and 208) can be configured for the different operating and control modes. The operating modes will be explained when referring to FIG. 43 and the control modes will be explained when referring to FIGS. 32, 33, 34, and 35. Referring to FIGS. 20-20B, it shows an isometric view of the left end effector 206 as well as an isolated view of the user hand coupler (218 or 228). The difference between user hand coupler 218 and 228 is the presence of load cell 1 99, where load cell 1 99 is present in hand coupler 228 but is excluded in hand coupler 218. There is no visual or functional mechanical difference between hand coupler 218 and 228. Similarly in FIGS. 22A-22B, it shows an isometric view of the right end effector 208.

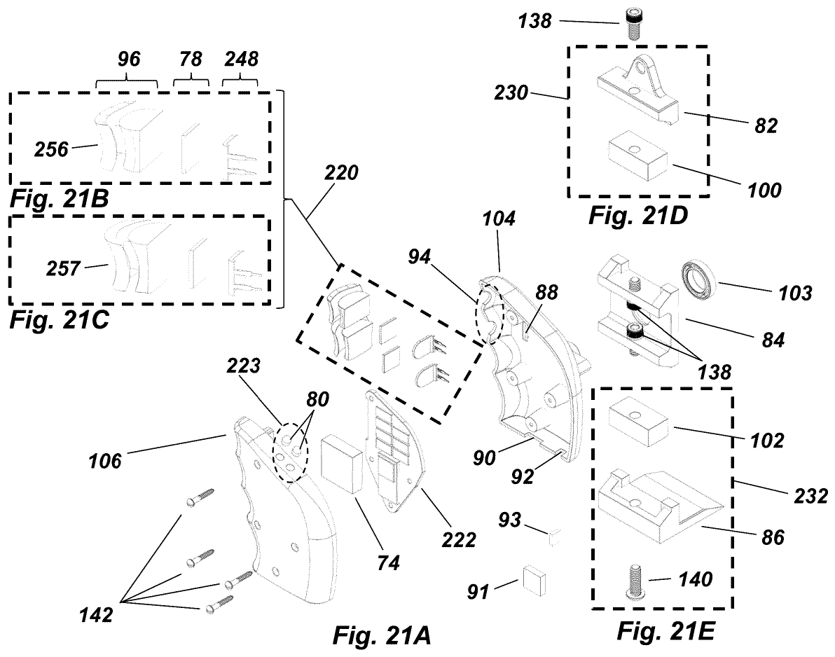

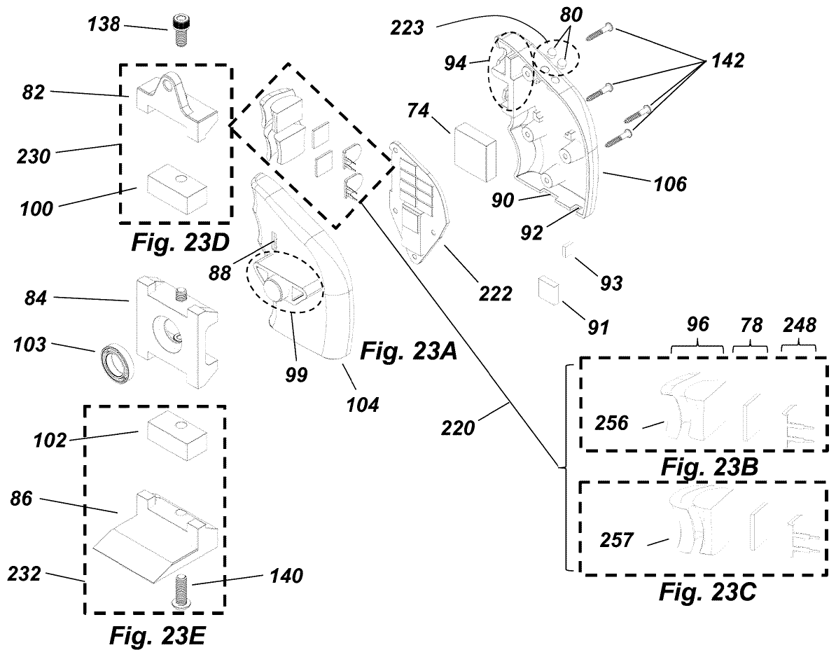

Referring to FIGS. 21A-21E, it opens up the left end effector 206 in an exploded view format. There are two main bodies to the end effector (EE), the user hand coupler (218 or 228 dependent on the control mode configuration of the end effector) and the interchangeable end effector attachment (consisting of load coupler 232, cable mount 230, and EE coupler middle 84). Starting with the user hand coupler (218 or 228), the components that make up this body include the screw configuration user hand coupler screws 142, EE palm side shell 106, status indicator (LED 1 & 2) 223, EE battery 74, EE electronics 222, user interface (buttons 1 & 2) 220 (which is comprised of the button shell 96, EE force sensitive button load concentrator 78, and the force sensitive resistor 248), and the EE load side shell 104. Working from left to right with these parts, there is screw configuration 142. These screws go into through holes and into countersunk holes for the screw heads to create a flush surface on the EE palm side shell 106. Then, these screws go into through holes on the EE electronics 222 and screw into threaded holes on the EE load side shell 104 enclosing all the specified parts above for the user hand coupler (218 or 228) body. The EE palm side shell 106 and EE load side shell 104 are designed to fit the contours of a human hand. Next, is the status indicator (LED 1 & 2) 223 which comprises of two LEDs 80 which will notify the user what mode the exoskeleton is in. The status indicator (LED 1 & 2) 223 is embedded into the EE palm side shell 106 to again create a flush surface for the user's thumb to rest on. The EE battery 74 fits into a snap-fit thin-walled placeholder inside the EE palm side shell 106. This snap-fit thin-walled placeholder is visible in FIG. 23A. Foam (not depicted in FIG. 21A) would also be used to rest snugly against the EE battery 74 and the EE electronics 222 once the user hand coupler (218 or 228) are screwed together. Next are the parts included in the user interface (buttons 1 & 2) 220. Button 1 256 for the index finger and button 2 257 for the middle finger comprise of a button shell 96, EE force sensitive button load concentrator 78, and force sensitive resistor 248. Button 1 256 and button 2 257 together create the user interface (buttons 1 & 2) 220. The button shell 96 is designed to fit the contours of the human fingers. The button shell 96 has a short circular rod extending out the backside of the face of the buttons which will insert into the EE index and middle finger button holes and backing wall 94, where the backing wall is not visible because it lies inside of the EE palm side shell 106. The backing wall 94 is visible in FIG. 23A. These holes are used to keep the buttons (256 and 257) in-position. Although not highlighted, the holes can be seen in FIG. 20A. The reason why the circular rod on the buttons (256 and 257) is so short is to keep the buttons as flush as possible to the user hand coupler (218 or 228) while leaving just a small amount of leeway to provide pressure to the force sensitive resistor 248. The flat portion on the back of the buttons (256 and 257) provides a consistent surface for the EE force sensitive button load concentrator 78 and the force sensitive resistor 248. There is a curved portion of each button that sits on the interior of the user hand coupler (218 or 228), and this is to match the body's contour to prevent button wobbling. Once the user interface (buttons 1 & 2) 220 is assembled, it slots into the EE index and middle finger button holes and backing wall 94. To generate a sensor reading, the force sensitive resistor 248 is pressed against the backing wall 94. The EE load side shell 104 contains a few key features. One of these features is the load cell 1 99 for automatic operating mode. This load cell is uniquely shaped to take advantage of strain gage positioning for sensing, but also to limit the interchangeable end effector attachment (consisting of load coupler 232, cable mount 230, and EE coupler middle 84) from rotating +/−45 degrees. Anymore rotations than this and it becomes inconvenient for the user when interfacing with an object to lift, lower, or hold. Extending off load cell 1 99 is a cylindrical shape that press-fits to the inner diameter of the EE ball bearing 103. This EE ball bearing is what connects the two main bodies together. Finally, there are various holes on the EE load side shell 104. Load cell plug-in wire hole 88 is used as an outlet for all the load cell wires to be plugged into in one convenient location out of the way from the user and the workspace. EE charging port 90 is a way for the user to easily plug in the end effectors (206 and 208) after use using the EE charging female connector 91. EE on/off switch hole 92 is for an EE on/off switch 93 to easily switch the end effectors on/off. The EE on/off switch 93 is flush to the bottom surface of the user hand coupler (218 or 228) such that the end effectors can be placed on a flat surface without tipping over.

The second main body for the end effectors (206 and 208) is the interchangeable end effector attachment shown in FIGS. 21A, 21D, and 21E. The parts that comprise the interchangeable end effector attachment are the screws from screw configurations top three end effector fasteners 138 and bottom end effector screw 140, cable mount w/sensor (load cell 2) 230 (which comprises of EE coupler top 82 and EE load cell 2 100), EE coupler middle 84, EE ball bearing 103, load coupler w/sensor (load cell 3) 232 (which comprises of EE coupler bottom 86 and EE load cell 3 102). Each of the four screws from screw configurations 138 and 140 screw into one half of a load cell (100 and 102) which has threaded holes. This is to create a tension only within the load cells (100 and 102) when a load is applied. Working from the top to bottom, EE coupler top 82 attaches to load cell 2 100. The EE coupler top 82 is where the nylon cables (202 and 204) tie to using a standard wire crimp. The EE coupler middle 84 connects to load cell 2 100 and load cell 3 102. The EE coupler bottom 86 then connects to the other half of load cell 3 102 using the screw from screw configuration 140. This screw is different from the screws in screw configuration 138 because it needs to be counter sunk into the EE coupler bottom 86 to create a flush surface if the end effectors (206 and 208) are placed on a flat surface to prevent tipping over just like the EE on/off switch 93 having to be flush. The difference in this screw configuration 140 is just having a low-profile screwhead. The EE coupler bottom 86 has a wedged surface to easily get under objects to be lifted for the user. This EE ball bearing 103 allows the interchangeable end effector attachment (consisting of load coupler 232, cable mount 230, and EE coupler middle 84) to rotate to make the coupling between the object and the user more convenient.

Referring to FIGS. 23A-23E, it is an exact mirrored image of the left end effector 206, but for the right end effector 208. FIGS. 23A-23E can show some additional features described previously such as highlighting the location and shape of load cell 1 99 attached to EE load side shell 104 and the backing walls 94 for the buttons to push against.

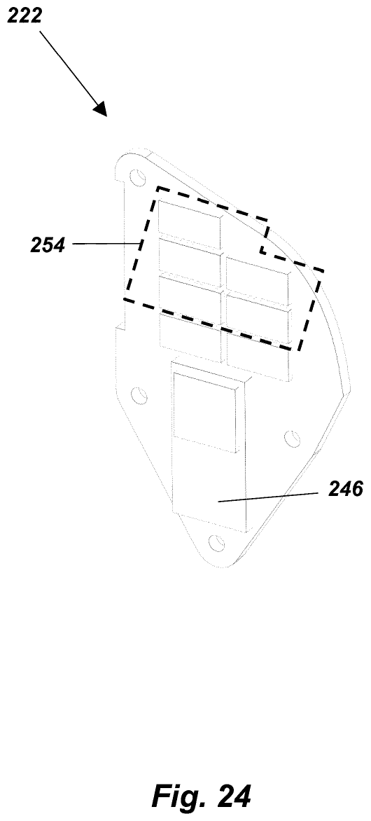

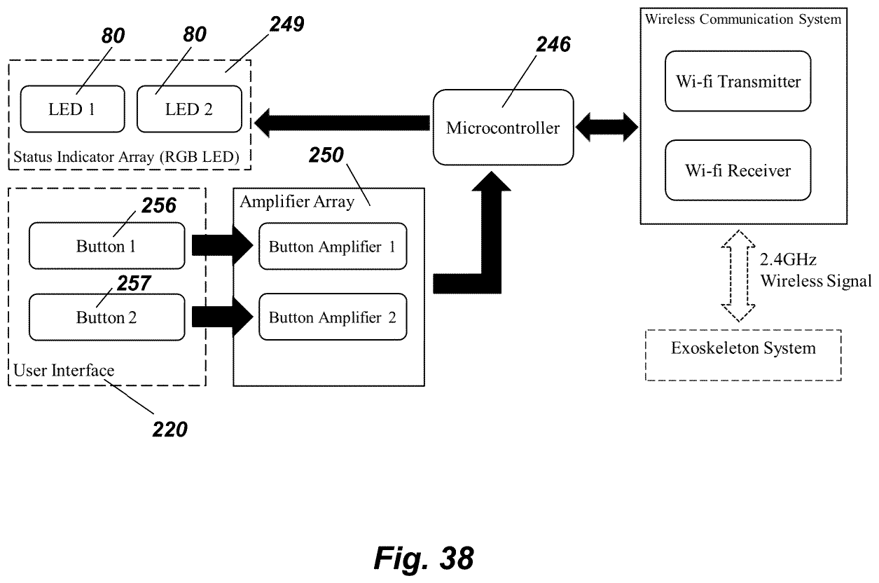

Referring to FIG. 24, it shows the mechanical arrangement of the end effector electronics 222 for end-effectors 206, 208. As will be discussed later, the microcontroller 246 is a wireless communication device to send control signals to and from the exoskeleton system 198. Amplifier array 254 represents a mechanical configuration suitable for any design configuration of end effectors 206, 208. These configurations will be described in detail in FIGS. 38, 39, and 40.

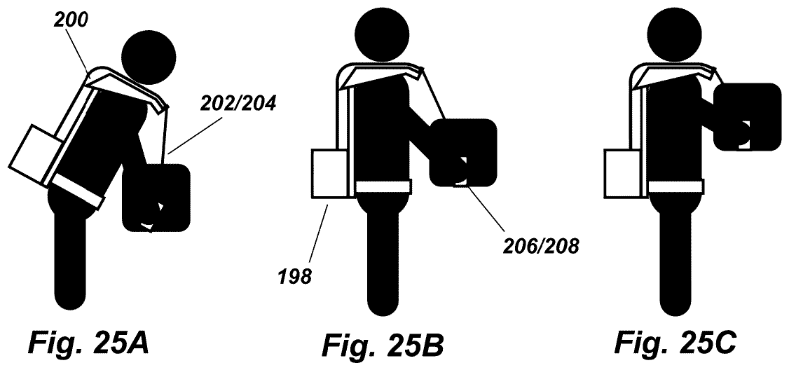

Referring to FIGS. 25A-25C, it shows a depiction of the exoskeleton (consisting of backpack harness 200 and exoskeleton system 198) being worn by a user to assist in lifting a load (box). The exoskeleton is to be worn on the back of the user using backpack harness 200 with the end-effectors 206, 208 being held in each hand. A cable attaches from the end-effectors 206, 208 to the cable actuation system 212 and braking system 214 in exoskeleton system 198. To assist the user to lift the load (box), the cable actuation system 212 pulls the cable by winding it around the right and left cable spools 216. The exoskeleton has the ability to assist the user in lifting, lowering, and holding a load. The user commands the exoskeleton to lift, lower, or hold a load by interacting with user interface 220 (consisting of force sensitive buttons) or load cells 252 located on end-effectors 206, 208.

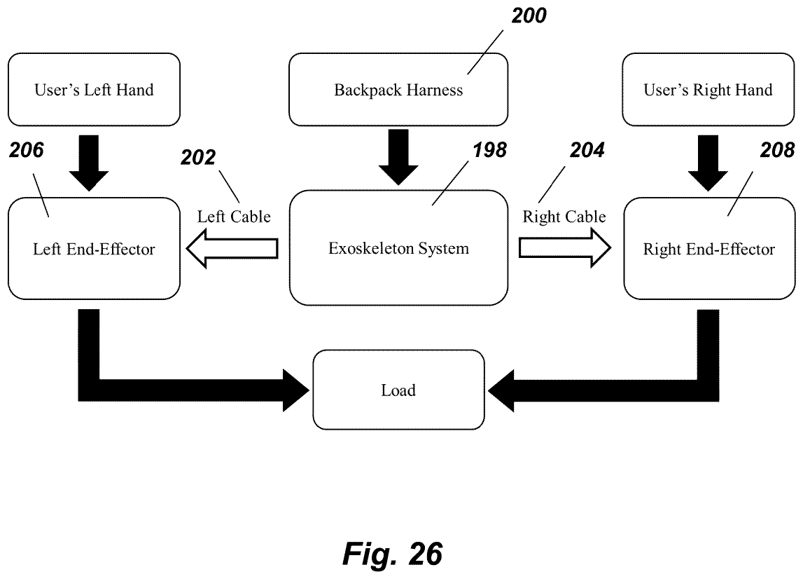

Referring to FIG. 26, it shows a high-level overview of the components of the exoskeleton (consisting of backpack harness 200, exoskeleton system 198, and right & left end-effectors 206, 208). Exoskeleton system 198 is physically connected to end-effectors 206, 208 by cables 202, 204. The user's right and left hands attach to end-effectors 208 and 206 respectively. The user places end-effectors 206, 208 around a load to couple to it. Exoskeleton system 198 then assists the user in lifting, lowering, or holding a load through actuation of cables 202, 204 which are mechanically connected to the load through end-effectors 206 and 208.

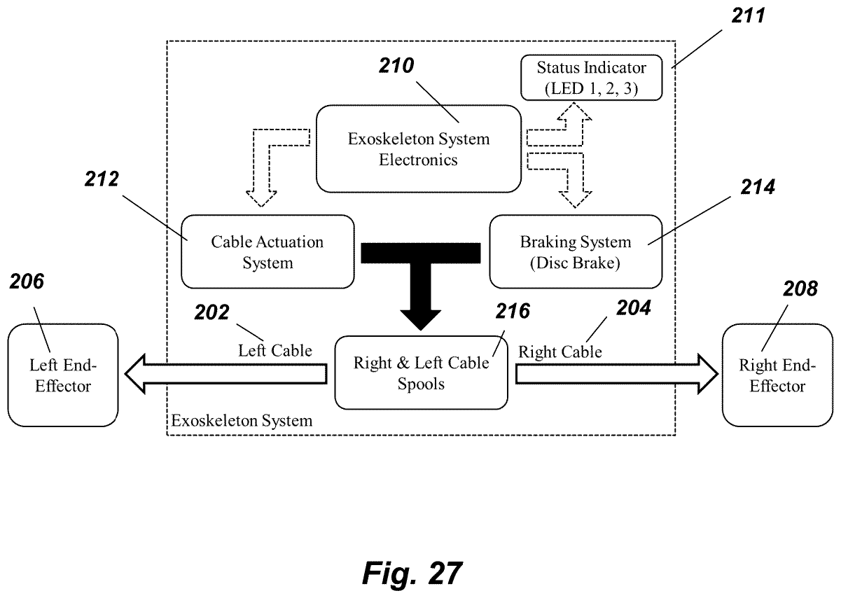

Referring to FIG. 27, it shows a close-up view of the internal components of exoskeleton system 198. The exoskeleton system electronics 210 is electrically connected to cable actuation system 212 and braking system (disc brake) 214 indicated by the black dotted arrows. The black dotted arrows represent electrical connectivity, and the solid black or solid black outlined arrows represent mechanical/physical connectivity. The direction of the arrows shows the direction of electrical or mechanical/physical flow to and from each component. The cable actuation system 212 and braking system (disc brake) 214 are directly connected to the right & left cable spools 216 indicated by the solid black arrows. The cables 202, 204 are directly connected to the right & left cable spools 216. The status indicator (LED 1, 2, 3) 211 is electrically connected to the exoskeleton system electronics 210. The end-effectors 206, 208 wirelessly send sensor inputs to the exoskeleton system electronics 210. Exoskeleton system electronics 210 drives and commands the cable actuation system 212 and braking system 214 to lift, lower, or hold a load based on the sensor values from end-effectors 206, 208. The cable actuation system 212 and right & left cable spools 216 are used to lift or lower a load by winding or unwinding cables 202, 204. The braking system (disc brake) 214 is used to apply a brake that stops the desired load from being lowered by unwanted external means (i.e., weight of load, user, etc.). Status indicator (LED 1, 2, 3) 211 consists of three RGB LEDs 80 that each give visual feedback to the user regarding important functions or information of the exoskeleton (LED output color is controlled by exoskeleton system electronics 210). RGB LED 1 80 shows the exoskeleton's overall functioning status (i.e. powering on, conducting startup sequence, system error, etc.) and status of end-effectors 206, 208 wireless connections to the exoskeleton system electronics 210 (ex. Green=Powering on/Startup Sequence, Flashing Blue=Pairing/Connecting to the End-Effectors (referring to the state of the art 802.11 technology), Solid Blue=All End-Effectors Connected, Red=Critical Error, etc.). RGB LED 2 80 shows the exoskeleton's battery level (ex. Green=100−75%, Yellow=74−50%, Orange=49−25%, Red=24−10%, Flashing Red=less than 10% etc.). RGB LED 3 80 shows which operating mode (shown in FIG. 43) is currently being used for commanding the exoskeleton to lift, lower, or hold a load (ex. Orange=Manual Operation Mode, Blue=Automatic Operation Mode).

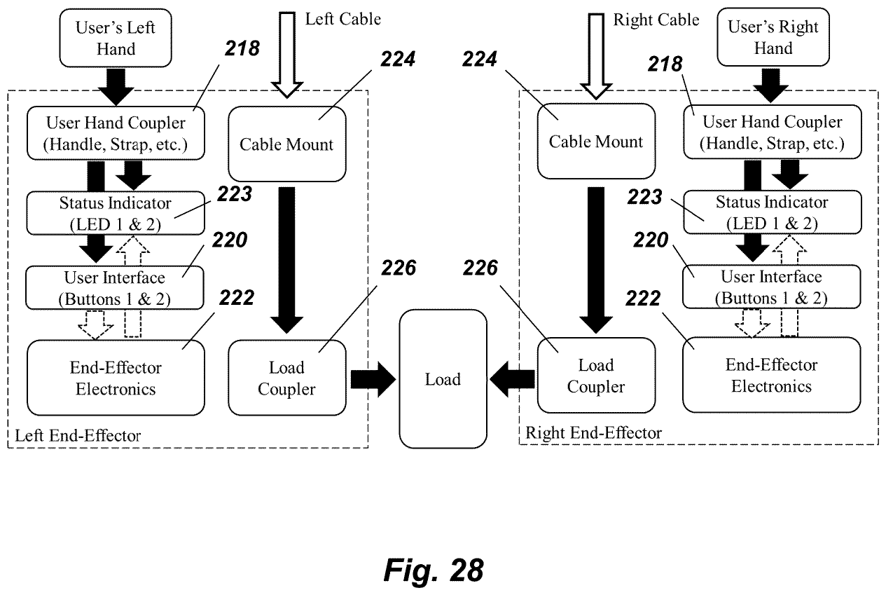

Referring to FIG. 28, it shows a close-up view of the internal components of design 1 of end-effectors 206, 208. The user's right and left hands attach to end-effectors 208 and 206 respectively via user hand coupler (handle, strap, etc.) 218. The user interface 220 (consisting of button 1 256 & button 2 257) is electrically connected to the end-effector electronics 222 indicated by the black dotted arrows. The black dotted arrows represent electrical connectivity, and the solid black or solid black outlined arrows represent mechanical/physical connectivity. The direction of the arrows shows the direction of electrical or mechanical/physical flow to and from each component. Status indicator (LED 1 & 2) 223 is electrically connected to end-effector electronics 222. Cables 202, 204 are mechanically/physically connected to end-effectors 206, 208 by cable mount 224. Cable mount 224 mechanically/physically connects to the load through load coupler 226. The user interface 220 (consisting of button 1 256 & button 2 257) is interacted with by the user's hands. The user indicates to lift, lower, or hold a load by the interaction with the user interface 220 (consisting of button 1 256 & button 2 257). The assistance of lifting, lowering, or holding a load is achieved by; the user coupling the end-effectors 206, 208 to the load; the connection of cables 202, 204 to the load via cable mount 224 and load coupler 226. The status indicator (LED 1 & 2) 223 consists of two RGB LEDs 80 that each give visual feedback to the user regarding important functions or information of end-effectors 206, 208 (LED output color is controlled by end-effector electronics 222). RGB LED 1 80 shows end-effectors 206, 208 overall functioning status (i.e. powering on, conducting startup sequence, system error, etc.) and status of end-effectors 206, 208 wireless connections to the exoskeleton system electronics 210 (ex. Green=Powering on/Startup Sequence, Flashing Blue=Pairing/Connecting to the End-Effectors (referring to the state of the art 802.11 technology), Solid Blue=All End-Effectors Connected, Red=Critical Error, etc.). RGB LED 2 80 shows the exoskeleton's battery level (ex. Green=100−75%, Yellow=74−50%, Orange=49−25%, Red=24−10%, Flashing Red=less than 10% etc.).

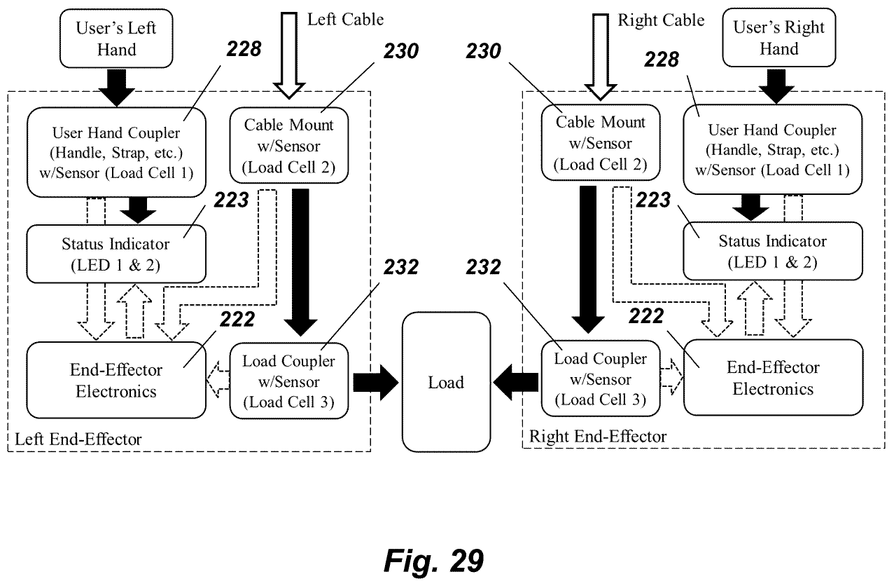

Referring to FIG. 29, it shows a close-up view of the internal components of design 2 of end-effectors 206, 208. The status indicator (LED 1 & 2) 223 is electrically connected (indicated by the black dotted arrow) to end-effector electronics 222. The black dotted arrows represent electrical connectivity, and the solid black or solid black outlined arrows represent mechanical/physical connectivity. The direction of the arrows shows the direction of electrical or mechanical/physical flow to and from each component. The user's right and left hands attach to end-effectors 208 and 206 respectively via user hand coupler (handle, strap, etc.) with sensor (load cell 1 99) 228. Load cells 1, 2 and 3 (parts 99, 100, and 102 respectively) are electrically connected to the end-effector electronics 222 and are integrated into the user hand coupler 228, cable mount 230, and load coupler 232 respectively. Cables 202, 204 are physically connected to end-effectors 206, 208 by cable mount 230. Cable mount 230 mechanically/physically connects to the load through load coupler 232. Load cell 2 in cable mount 230 is interacted with by tension forces placed on cables 202, 204 due to external forces (i.e., cable actuation system 212, user, weight of load, etc.). Load cell 3 102 in load coupler 232 is interacted directly by the weight of the load. Load cell 1 99 in the user hand coupler 228 is interacted with by external forces due to tension in cables 202, 204, weight of load, and forces applied by the user. Load cell 1 (integrated in user hand coupler 228) 99 measures forces placed directly on the user's right and left hands, load cell 2 (integrated in cable mount 230) 100 measures cable tension forces placed on the end-effectors 206, 208, and load cell 3 (integrated in load coupler 232) 102 measures forces placed directly on end-effectors 206, 208. The user can indicate to lift, lower, or hold a load due to the exoskeleton system electronics 210 automatically detecting whether the user is trying to either lift, lower, or hold a load based on sensor values from load cells 1, 2, and 3 (parts 99, 100, 102 integrated in user hand coupler 228, cable mount 230, and load coupler 232 respectively). The automatic detection is achieved by the user indirectly interacting with load cells 1, 2, 3 (parts 99, 100, and 102 respectively) by; raising end-effectors 206, 208 to indicate to lift; pulling down on end-effectors 206, 208 to indicate to lower; keeping end-effectors 206, 208 stationary to indicate to hold. The assistance of lifting, lowering, or holding a load is achieved by; the user coupling the end-effectors 206, 208 to the load; the connection of cables 202, 204 to the load via cable mount 230 and load coupler 232. Status indicator (LED 1 & 2) 223 consists of two RGB LEDs 80 that each give visual feedback to the user regarding important functions or information of end-effectors 206, 208 (LED output color is controlled by end-effector electronics 222). RGB LED 1 80 shows end-effectors 206, 208 overall functioning status (i.e. powering on, conducting startup sequence, system error, etc.) and status of end-effectors 206, 208 wireless connections to the exoskeleton system electronics 210 (ex. Green=Powering on/Startup Sequence, Flashing Blue=Pairing/Connecting to the End-Effectors (referring to the state of the art 802.11 technology), Solid Blue=All End-Effectors Connected, Red=Critical Error, etc.). RGB LED 2 80 shows the exoskeleton's battery level (ex. Green=100−75%, Yellow=74−50%, Orange=49−25%, Red=24−10%, Flashing Red=less than 10% etc.).

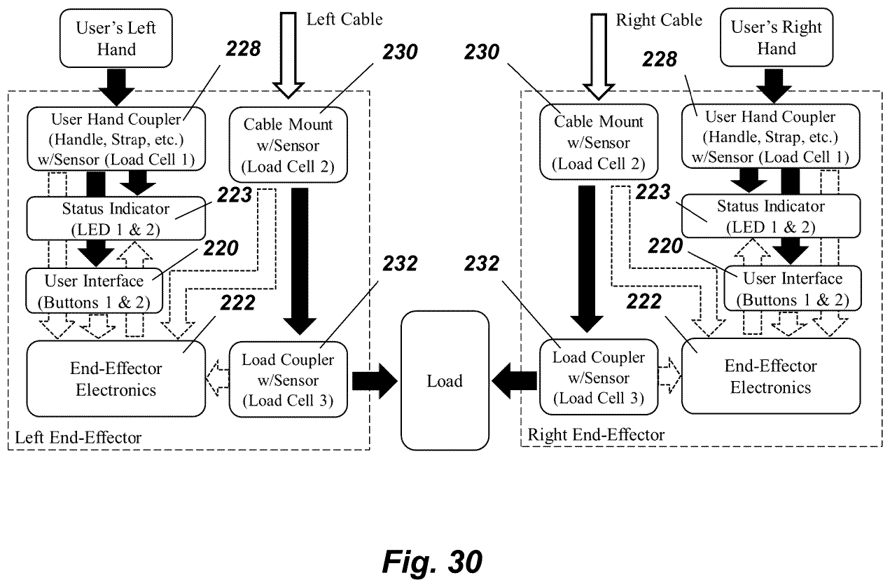

Referring to FIG. 30, it shows a close-up view of the internal components of design 3 of end-effectors 206, 208. Design 3 incorporates sensors from both end-effector designs 1 & 2 (user interface 220 (consisting of force sensitive button 1 256 & force sensitive button 2 257) and load cells 252 (consisting of load cell 1 99, load cell 2 100, and load cell 3 102)). Design 3 can switch between/operate as either design 1 or design 2 (designs 1 & 2 are shown in FIGS. 28 and 29 respectively). The status indicator (LED 1 & 2) 223 is electrically connected (indicated by the black dotted arrow) to end-effector electronics 222. The black dotted arrows represent electrical connectivity, and the solid black or solid black outlined arrows represent mechanical/physical connectivity. The direction of the arrows shows the direction of electrical or mechanical/physical flow to and from each component. The user interface 220 (consisting of force sensitive button 1 256 & force sensitive button 2 257) is electrically connected to the end-effector electronics 222. Load cells 1, 2 and 3 (parts 99, 100, and 102 respectively) are electrically connected to the end-effector electronics 222 and are integrated into the user hand coupler 228, cable mount 230, and load coupler 232 respectively. Cables 202, 204 are mechanically/physically connected to end-effectors 206, 208 by cable mount 230. Cable mount 230 mechanically/physically connects to the load through load coupler 232. Status indicator (LED 1 & 2) 223 consists of two RGB LEDs 80 that each give visual feedback to the user regarding important functions or information of end-effectors 206, 208 (LED output color is controlled by end-effector electronics 222). RGB LED 1 80 shows end-effectors 206, 208 overall functioning status (i.e. powering on, conducting startup sequence, system error, etc.) and status of end-effectors 206, 208 wireless connections to the exoskeleton system electronics 210 (ex. Green=Powering on/Startup Sequence, Flashing Blue=Pairing/Connecting to the End-Effectors (referring to the state of the art 802.11 technology), Solid Blue=All End-Effectors Connected, Red=Critical Error, etc.). RGB LED 2 80 shows the exoskeleton's battery level (ex. Green=100−75%, Yellow=74−50%, Orange=49−25%, Red=24−10%, Flashing Red=less than 10% etc.).

In operation as design 1, the user interface 220 (consisting of button 1 256 & button 2 257) is interacted with by the user's hands. The user indicates to lift, lower, or hold a load by the interaction with the user interface 220 (consisting of button 1 256 & button 2 257). The assistance of lifting, lowering, or holding a load is achieved by; the user coupling the end-effectors 206, 208 to the load; the connection of cables 202, 204 to the load via cable mount 230 and load coupler 232.

In operation as design 2, the user's right and left hands attach to end-effectors 208 and 206 respectively via user hand coupler (handle, strap, etc.) with sensor (load cell 1 99) 228. Load cell 2 100 in cable mount 230 is interacted with by tension forces placed on cables 202, 204 due to external forces (i.e., cable actuation system 212, user, weight of load, etc.). Load cell 3 102 in load coupler 232 is interacted directly by the weight of the load. Load cell 1 99 in the user hand coupler 228 is interacted with by external forces due to tension in cables 202, 204, weight of load, and forces applied by the user. Load cell 1 (integrated in user hand coupler 228) 99 measures forces placed directly on the user's right and left hands, load cell 2 (integrated in cable mount 230) 100 measures cable tensional forces placed on the end-effectors 206, 208, and load cell 3 (integrated in load coupler 232) 102 measures forces placed directly on end-effectors 206, 208. The user can indicate to lift, lower, or hold a load due to the exoskeleton system electronics 210 automatically detecting whether the user is trying to either lift, lower, or hold a load based on sensor values from load cells 1, 2, and 3 (parts 99, 100, 102 integrated in user hand coupler 228, cable mount 230, and load coupler 232 respectively). The automatic detection is achieved by the user indirectly interacting with load cells 1, 2, 3 (parts 99, 100, 102 respectively) by; raising end-effectors 206, 208 to indicate to lift; pulling down on end-effectors 206, 208 to indicate to lower; keeping end-effectors 206, 208 stationary to indicate to hold. The assistance of lifting, lowering, or holding a load is achieved by; the user coupling the end-effectors 206, 208 to the load; the connection of cables 202, 204 to the load via cable mount 230 and load coupler 232.

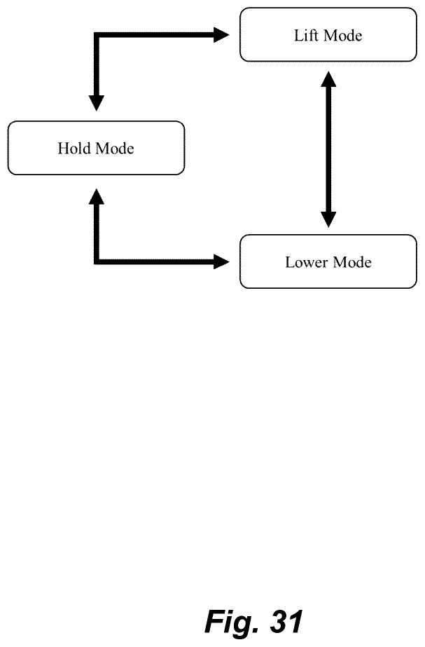

Referring to FIG. 31, it shows a general overview of the control modes used by the exoskeleton (consisting of backpack harness 200, exoskeleton system 198, and right & left end-effectors 206, 208) to assist a user to lift, lower, or hold a load. The connections show how each mode can switch and transition between each other. The lift mode occurs when the exoskeleton is actively assisting a user to lift a load, the lower mode occurs when the exoskeleton is actively lowering the load, and the hold mode occurs when the exoskeleton is holding the load.

Referring to FIG. 32, it shows a close-up view of the lift, lower, and hold modes including the conditions required to activate each mode for end-effector 206, 208 designs 1 & 3 (designs 1 & 3 are shown in FIGS. 28 and 30 respectively). The user can indicate for the exoskeleton (consisting of backpack harness 200 and exoskeleton system 198) to lift, lower, or hold a load by interacting with the user interface 220 (consisting of force sensitive button 1 256 & force sensitive button 2 257) on end-effectors 206, 208 using the right and left hands. The lift mode is activated when button 1 value is greater than zero and button 2 value is roughly zero. Once activated, the cable actuation system 212 winds cables 202, 204 on the right and left cable spools 216 pulling end-effectors 206, 208 upwards at a speed indicated by the magnitude of button 1 value (more force on the button means greater magnitude which means faster speed). The lower mode is activated when button 2 is greater than zero and button 1 is roughly zero. Once activated, the cable actuation system 212 unwinds cables 202, 204 on the right and left cable spools 216 releasing tension on the end-effectors 206, 208 at a speed indicated by the magnitude of the button 2 value (more force on the button means greater magnitude which means faster speed). The hold mode is activated when buttons 1 & 2 are both either greater than zero or roughly zero. Once activated, the braking system 214 applies a break on the right & left cable spools 216 which prevents cables 202, 204 and end-effectors 206, 208 from falling/unreeling due to external forces (i.e., user, weight of load). For safe operation using user interface 220, predetermined maximum values for the lifting/lowering speeds, accelerations, and decelerations (i.e. values used in lifting & lowering modes) are set in software to prevent the user from commanding dangerous operating speeds, accelerations, or decelerations that are greater than the maximum values.

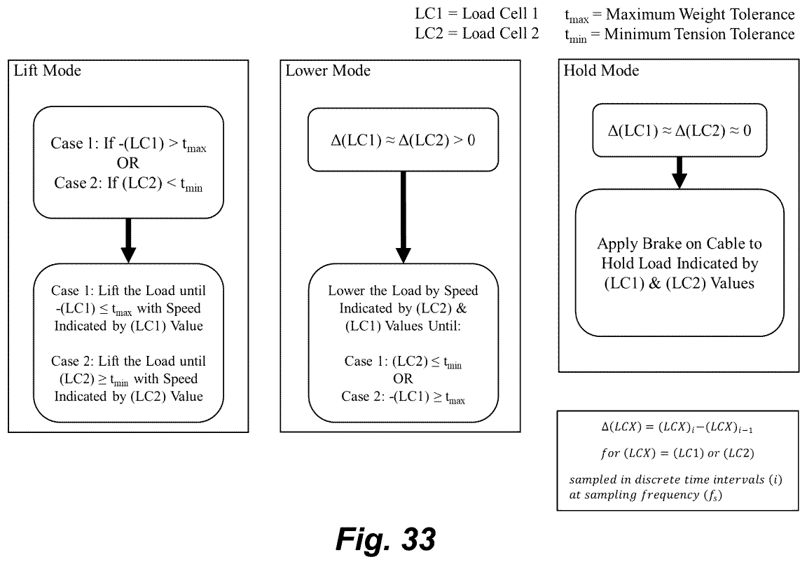

Referring to FIGS. 33, 34, and 35, they show a close-up view of the control modes (consisting of the lift, lower, and hold modes) including the conditions required to activate each mode for end-effector 206, 208 designs 2 & 3 (designs 2 & 3 are shown in FIGS. 29 and 30 respectively). The user can indicate to lift, lower, or hold a load due to microcontroller 236 in exoskeleton system electronics 210 automatically detecting whether the user is trying to either lift, lower, or hold a load based on voltage values from load cells 1, 2, and 3 (parts 99, 100, 102 integrated in user hand coupler 228, cable mount 230, and load coupler 232 respectively). The automatic detection is achieved by the user indirectly interacting with load cells 1, 2, 3 (parts 99, 100, 102 respectively) by; raising the end-effectors 206, 208 to indicate to lift; pulling down on end-effectors 206, 208 to indicate to lower; keeping end-effectors 206, 208 stationary to indicate to hold. Different combinations of load cells 1, 2, 3 that support automatic detection capabilities include; load cells 1 and 2 (parts 99 and 100 respectively); load cells 2 and 3 (parts 100 and 102 respectively); load cells 1, 2, and 3 (parts 99, 100, 102 respectively).

Regarding FIG. 33, it shows the conditions required for activation of each control mode (lift, lower, hold modes) using load cells 1 & 2 (parts 99 and 100 respectively) in end-effector 206, 208 designs 2 & 3 (designs 2 & 3 are shown in FIGS. 29 and 30 respectively). The lift mode is activated when case conditions 1 or 2 are satisfied. Case condition 1 accounts for lift mode activation when influenced by a load. Case condition 2 accounts for lift mode activation in a no-load scenario. Case 1 is satisfied when load cell 1 value is greater than the maximum weight tolerance (tₘₐₓ). The maximum weight tolerance (tₘₐₓ) is defined as the maximum desired weight experienced by the user measured by load cell 1 99. For example, with 20 lbs load and tₘₐₓ set to 5 lbs, the exoskeleton would support 15 lbs or 75 % of the total load. The tₘₐₓ can be adjusted by the user based on preference and desired perception of the load. Once case 1 is satisfied, the cable actuation system 212 winds cables 202, 204 on the right and left cable spools 216 pulling end-effectors 206, 208 upwards at a speed indicated by load cell 1 value (greater load cell 1 value means faster speed) until load cell 1 value is less than or equal to the maximum weight tolerance. Case 2 is satisfied when load cell 2 value is less than the minimum tension tolerance (tₘᵢₙ). The minimum tension tolerance (tₘᵢₙ) is defined as the minimum desired tension in the cable as measured by load cell 2 100. This is designed to retain cable tension between the spools 216 and the end effectors 206 and 208. tₘᵢₙ can be adjusted by the user based on preference. Once case 2 is satisfied, the cable actuation system 212 winds cables 202, 204 on the right and left cable spools 216 pulling end-effectors 206, 208 upwards at a speed indicated by load cell 2 value (smaller load cell 2 value means faster speed) until load cell 2 value is greater than or equal to the minimum tension tolerance. The lower mode is activated when the change in load cell 1 value is roughly equal to the change in load cell 2 value and is greater than zero. The delta (□) symbol represents the change in the value of a variable in time (i.e. the difference between two points) sampled in discrete time intervals at a specified sampling frequency. This mode is activated in either of the following scenarios; when influenced by a load and when in a no-load scenario. Once activated, the cable actuation system 212 unwinds cables 202, 204 on the right and left cable spools 216 releasing tension on the end-effectors 206, 208 at a speed indicated by load cell 1 & load cell 2 values (greater load cell 1 value and smaller load cell 2 value means faster speed) until load cell 2 value is less than or equal to the minimum tension tolerance or load cell 1 value is greater than or equal to the maximum weight tolerance. The hold mode is activated when the change in load cell 1 value is roughly equal to the change in load 2 value and is roughly equal to zero. This mode is activated in either of the following scenarios; when influenced by a load and when in a no-load scenario. Once activated, the braking system 214 applies a break on the right & left cable spools 216 which prevents cables 202, 204 and end-effectors 206, 208 from falling/unreeling due to external forces (i.e., user, weight of load).

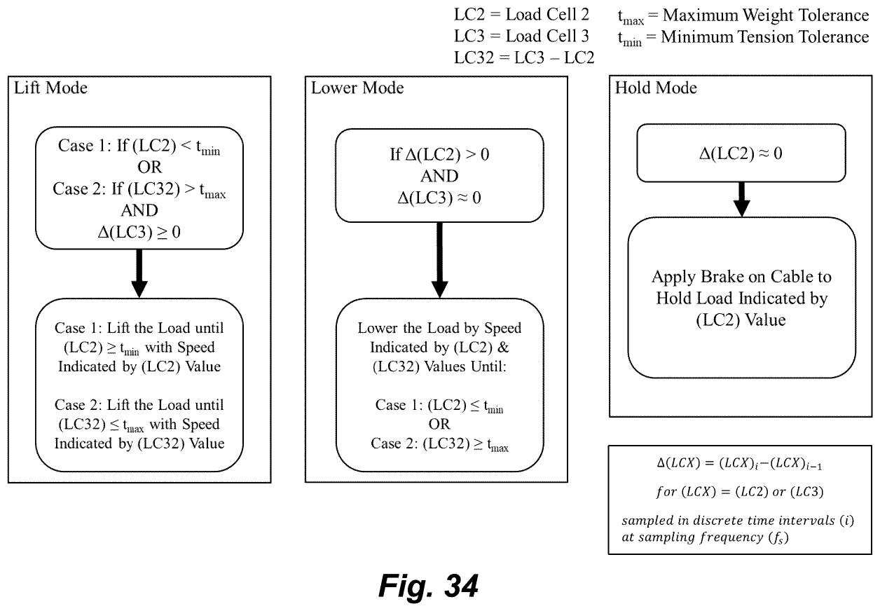

Regarding FIG. 34, it shows the conditions required for activation of each control mode (lift, lower, hold modes) using load cells 2 & 3 (parts 100 and 102 respectively) in end-effector 206, 208 designs 2 & 3 (designs 2 & 3 are shown in FIGS. 29 and 30 respectively). The lift mode is activated when case conditions 1 or 2 are satisfied. Case condition 1 accounts for lift mode activation in a no-load scenario. Case condition 2 accounts for lift mode activation when influenced by a load. Case 1 is satisfied when load cell 2 value is less than the minimum tension tolerance (tₘᵢₙ). The minimum tension tolerance (tₘᵢₙ) is defined as the minimum desired tension in the cable as measured by load cell 2 100. This is designed to retain cable tension between the spools 216 and the end effectors 206 and 208. tₘᵢₙ can be adjusted by the user based on preference. Once case 1 is satisfied, the cable actuation system 212 winds cables 202, 204 on the right and left cable spools 216 pulling end-effectors 206, 208 upwards at a speed indicated by load cell 2 value (smaller load cell 2 value means faster speed) until load cell 2 value is greater than or equal to the minimum tension tolerance. Case 2 is satisfied when the difference between load cell 3 value and load cell 2 value is greater than the maximum weight tolerance (tₘₐₓ) and the change in the load cell 3 value is greater than or equal to zero. The maximum weight tolerance (tₘₐₓ) is defined as the maximum desired weight experienced by the user measured by the difference between load cell 3 102 and load cell 2 100. For example, with 20 lbs load and tₘₐₓ set to 5 lbs, the exoskeleton would support 15 lbs or 75 % of the total load. tₘₐₓ can be adjusted by the user based on preference and desired perception of the load. The delta (□) symbol represents the change in the value of a variable in time (i.e. the difference between two points) sampled in discrete time intervals at a specified sampling frequency. Once case 2 is satisfied, the cable actuation system 212 winds cables 202, 204 on the right and left cable spools 216 pulling end-effectors 206, 208 upwards at a speed indicated by the difference between load cell 3 value and load cell 2 value (greater difference value means faster speed) until the difference value is less than or equal to the maximum weight tolerance. The lower mode is activated when the change in load cell 2 value is greater than zero and the change in load cell 3 value is roughly equal to zero. This mode is activated in either of the following scenarios; when influenced by a load and when in a no-load scenario. Once activated, the cable actuation system 212 unwinds cables 202, 204 on the right and left cable spools 216 releasing tension on the end-effectors 206, 208 at a speed indicated by load cell 2 & the difference between load cells 3 and 2 (greater difference value and smaller load cell 2 value means faster speed) until load cell 2 value is less than or equal to the minimum tension tolerance or the difference between load cell 3 and 2 value is greater than or equal to the maximum weight tolerance. The hold mode is activated when the change in load cell 2 value is roughly equal to zero. This mode is activated in either of the following scenarios; when influenced by a load and when in a no-load scenario. Once activated, the braking system 214 applies a break on the right & left cable spools 216 which prevents cables 202, 204 and end-effectors 206, 208 from falling/unreeling due to external forces (i.e., user, weight of load).

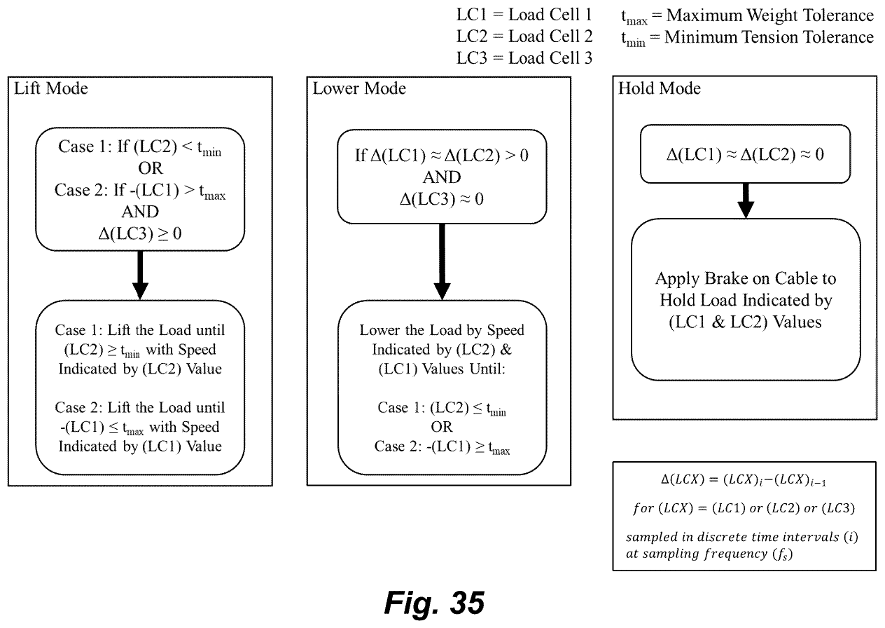

Regarding FIG. 35, it shows the conditions required for activation of each control mode (lift, lower, hold modes) using load cells 1, 2 and 3 (parts 99, 100, 102 respectively) in end-effector 206, 208 designs 2 & 3 (designs 2 & 3 are shown in FIGS. 29 and 30 respectively). The lift mode is activated when case conditions 1 or 2 are satisfied. Case condition 1 accounts for lift mode activation in a no-load scenario. Case condition 2 accounts for lift mode activation when influenced by a load. Case 1 is satisfied when load cell 2 value is less than the minimum tension tolerance (tₘᵢₙ). The minimum tension tolerance (tₘᵢₙ) is defined as the minimum desired tension in the cable as measured by load cell 2 100. This is designed to retain cable tension between the spools 216 and the end effectors 206 and 208. tₘᵢₙ can be adjusted by the user based on preference. Once case 1 is satisfied, the cable actuation system 212 winds cables 202, 204 on the right and left cable spools 216 pulling end-effectors 206, 208 upwards at a speed indicated by load cell 2 value (smaller load cell 2 value means faster speed) until load cell 2 value is greater than or equal to the minimum tension tolerance. Case 2 is satisfied when load cell 1 value is greater than the maximum weight tolerance (tₘₐₓ) and the change in the load cell 3 value is greater than or equal to zero. The maximum weight tolerance (tₘₐₓ) is defined as the maximum desired weight experienced by the user measured by load cell 1 99. For example, with 20 lbs load and tₘₐₓ set to 5 lbs, the exoskeleton would support 15 lbs or 75 % of the total load. tₘₐₓ can be adjusted by the user based on preference and desired perception of the load. The delta (□) symbol represents the change in the value of a variable in time (i.e. the difference between two points) sampled in discrete time intervals at a specified sampling frequency. Once case 2 is satisfied, the cable actuation system 212 winds cables 202, 204 on the right and left cable spools 216 pulling end-effectors 206, 208 upwards at a speed indicated by load cell 1 value (greater load cell 1 value means faster speed) until the load cell 1 value is less than or equal to the maximum weight tolerance. The lower mode is activated when the change in load cell 1 value is roughly equal to the change in load cell 2 value and are greater than zero and load cell 3 value is roughly equal to zero. This mode is activated in either of the following scenarios; when influenced by a load and when in a no-load scenario. Once activated, the cable actuation system 212 unwinds cables 202, 204 on the right and left cable spools 216 releasing tension on the end-effectors 206, 208 at a speed indicated by load cell 1 & load cell 2 (greater load cell 1 value and smaller load cell 2 value means faster speed) until load cell 2 value is less than or equal to the minimum tension tolerance or load cell 1 value is greater than or equal to the maximum weight tolerance. The hold mode is activated when the change in load cell 1 value and the change in load cell 2 is roughly equal to zero. This mode is activated in either of the following scenarios; when influenced by a load and when in a no-load scenario. Once activated, the braking system 214 applies a break on the right & left cable spools 216 which prevents cables 202, 204 and end-effectors 206, 208 from falling/unreeling due to external forces (i.e., user, weight of load).

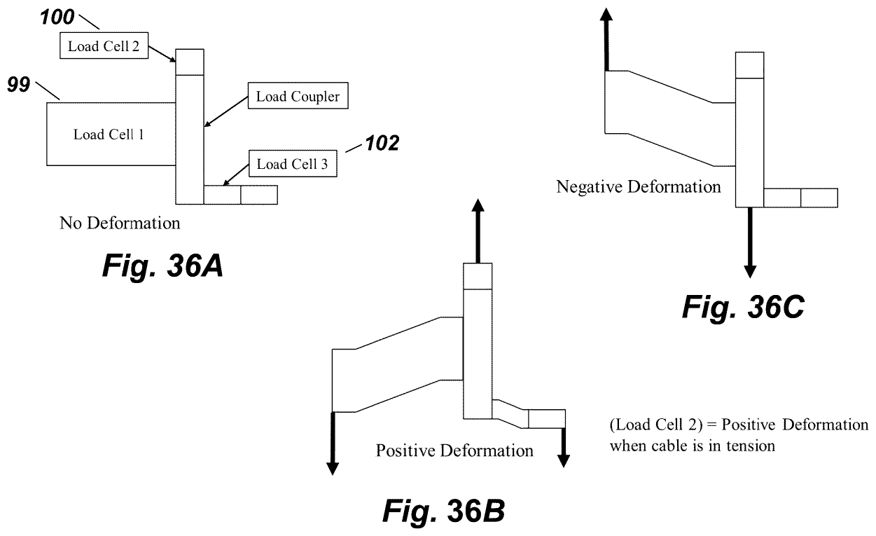

Referring to FIG. 36A-36C, it shows a depiction of load cells 1, 2, and 3 (parts 99, 100, 102 respectively) configuration/positioning on end-effectors 206, 208 and the deformation directions for end-effector 206, 208 designs 2 & 3 (designs 2 & 3 are shown in FIGS. 29 and 30 respectively). Three deformation scenarios are depicted to show no deformation, positive deformation, and negative deformation. Load cell 1 99 is connected to load coupler 232 & integrated in user hand coupler 228, load cell 2 100 is connected to load coupler 232 & integrated in cable mount 230, and load cell 3 102 is connected to & integrated in load coupler 232. The user hand coupler 228 is connected to the left of load cell 1 (not depicted in FIGS. 36A-36C). Load cells with no deformation have a value of zero or about zero, load cells with positive deformation have a value greater than zero, and load cells with negative deformation have a value less than zero. In the no deformation scenario, no forces are applied to load cells 1, 2, and 3 (parts 99, 100, 102 respectively). In the positive deformation scenario, an upwards force (forces are represented by large black arrows) is applied to load cell 2 100 (due to tension from cables 202, 204) and a downwards force is applied to load cell 1 99 (due to either the user restricting an upwards motion due to tension from cables 202, 204 or from the user pulling down on end-effectors 206, 208) and load cell 3 102 (due to the weight of a load). In the negative deformation scenario, an upwards force is applied to load cell 1 99 due to the user restricting downwards motion due to the weight of a load (weight of a load is represented by the large black downwards arrow under load coupler 232).

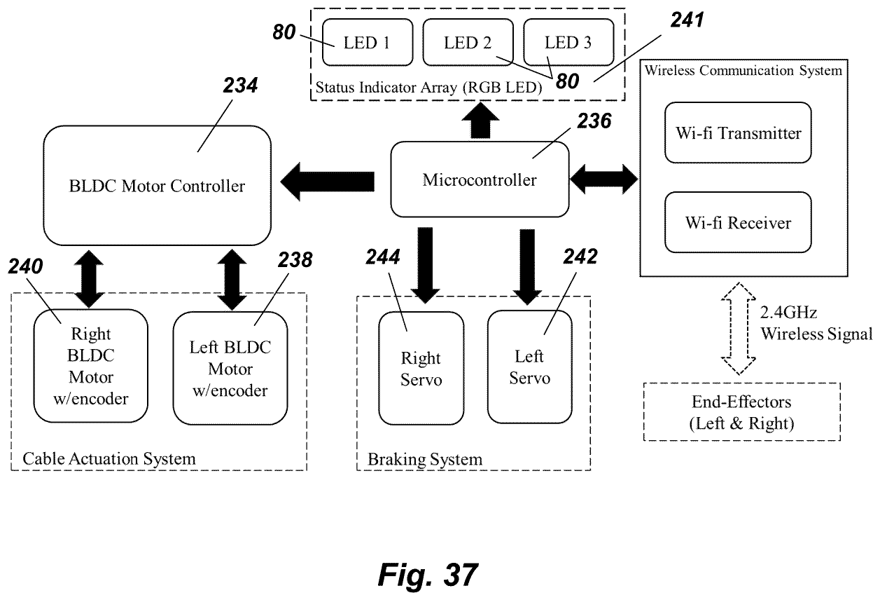

Referring to FIG. 37, it shows a close-up view of the internal components of the exoskeleton system electronics 210. The exoskeleton system electronics 210 consists of microcontroller 236, BLDC motor controller 234, cable actuation system 212, braking system 214, status indicator array (RGB LED) 241, and wireless communication system (consisting of a Wi-Fi transmitter & receiver). The right & left servos 244, 242 are electrically connected to microcontroller 236. Microcontroller 236 is electrically connected to the right & left servos 244, 242, BLDC motor controller 234, status indicator array (RGB LED) 241, and wireless communication system. The BLDC motor controller 234 is electrically connected to microcontroller 236 and the right & left BLDC motors with encoders 240, 238 respectively. The cable actuation system 212 consists of two actuators, the right BLDC motor with encoder 240 and the left BLDC motor with encoder 238. The status indicator array (RGB LED) 241 consists of three RGB LEDs 80 labeled LED 1, LED 2, and LED 3. LED 1 80, LED 2 80, and LED 3 80 are integrated in part 41 in the spine and shoulders section of the exoskeleton (shown in FIG. 9) and are electrically connected to microcontroller 236. The status indicator array 241 gives visual feedback to the user regarding important functions or information of the exoskeleton. RGB LED 1 80 shows the exoskeleton's overall functioning status (i.e. powering on, conducting startup sequence, etc.) and status of end-effectors 206, 208 wireless connections to the exoskeleton system electronics 210 (ex. Green=Powering on/Startup Sequence, Flashing Blue=Pairing/Connecting to the End-Effectors (referring to the state of the art 802.11 technology), Solid Blue=All End-Effectors Connected, Red=Critical Error, etc.). RGB LED 2 80 shows the exoskeleton's battery level (ex. Green=100−75%, Yellow=74−50%, Orange=49−25%, Red=24−10%, Flashing Red=less than 10% etc.). RGB LED 3 80 shows which operating mode (discussed in FIG. 43) is currently being used for commanding the exoskeleton to lift, lower, or hold a load (ex. Orange=Manual Operation Mode, Blue=Automatic Operation Mode). The braking system 214 consists of two actuators, right servo 244 and left servo 242. The right & left BLDC motors 240, 238 are directly connected to the right & left cable spools 216 to actuate cables 202, 204 and end-effectors 206, 208. The braking system (disc brake) 214 is directly connected in-between the cable actuation system 212 and the right & left cable spools 216. The right & left servos 244, 242 applies a brake, restricting rotation of right & left cable spools 216 and right & left BLDC motors 240, 238, through actuating brake pads producing a clamping force on the disc brake of braking system 214. The microcontroller 236 controls the; cable actuation system indirectly through the BLDC motor controller 234 (controls the position and rotation speed of each BLDC motor 240, 238); braking system 214 directly with the right & left servos 244, 242 (controls the angle of each servo); status indicator (LED 1, 2, 3) 211 directly with LEDs 1, 2, & 3 in status indicator array (RGB LED) 241 (controls the output color for each LED); and wireless communication system directly by sending and receiving Wi-Fi packets sent and received from each end-effector microcontroller 246 from end-effectors 206, 208.

Referring to FIG. 38, it shows a close-up view of the internal components of the end-effector electronics 222 in design 1 of end-effectors 206, 208. End-effector design 1 is shown in FIG. 28. The end-effector electronics 222 consists of microcontroller 246, user interface 220 (consisting of force sensitive button 1 256 and force sensitive button 2 257), amplifier array 250 (consisting of button amplifiers 1 & 2 for button 1 256 & button 2 257 respectively), status indicator array (RGB LED) 249 (consisting of LED 1 80 and 2 80), and wireless communication system (consisting of a Wi-Fi transmitter & receiver). Status indicator array (RGB LED) 249 consisting of LED 1 80 and LED 2 80 are electrically connected to microcontroller 246. User interface 220 is electrically connected to the amplifier array 250. Button 1 256 in the user interface 220 is electrically connected to button amplifier 1 in the amplifier array 250. Button 2 257 in the user interface 220 is electrically connected to button amplifier 2 in the amplifier array 250. Microcontroller 246 is electrically connected to the amplifier array 250 and the wireless communication system. Status indicator (LED 1 & 2) 223 consists of two RGB LEDs 80 that each give visual feedback to the user regarding important functions or information of end-effectors 206, 208 (LED output color is controlled by end-effector electronics 222). RGB LED 1 80 shows end-effectors 206, 208 overall functioning status (i.e. powering on, conducting startup sequence, system error, etc.) and status of end-effectors 206, 208 wireless connections to the exoskeleton system electronics 210 (ex. Green=Powering on/Startup Sequence, Flashing Blue=Pairing/Connecting to the End-Effectors (referring to the state of the art 802.11 technology), Solid Blue=All End-Effectors Connected, Red=Critical Error, etc.). RGB LED 2 80 shows the exoskeleton's battery level (ex. Green=100−75%, Yellow=74−50%, Orange=49−25%, Red=24−10%, Flashing Red=less than 10% etc.). Buttons 1 & 2 are force sensitive resistive sensors and make up the user interface 220 on end-effectors 206, 208. The user can indicate for the exoskeleton (consisting of backpack harness 200, exoskeleton system 198, and right & left end-effectors 206, 208) to lift, lower, or hold a load by interacting with user interface 220 (consisting of force sensitive button 1 256 and force sensitive button 2 257) on end-effectors 206, 208 using the right and left hands. Forces applied on buttons 1 & 2 result in a change in resistance. Button amplifiers 1 & 2 in the amplifier array 250 convert and amplify small changes in resistance of buttons 1 & 2 (due to external forces on the force sensitive buttons 1 & 2 from the user) into a measurable voltage that microcontroller 246 can detect and measure. The microcontroller 246 controls the wireless communication system directly by sending Wi-Fi packets (consisting of the measured analog voltages of buttons 1 & 2) to the exoskeleton system microcontroller 236.

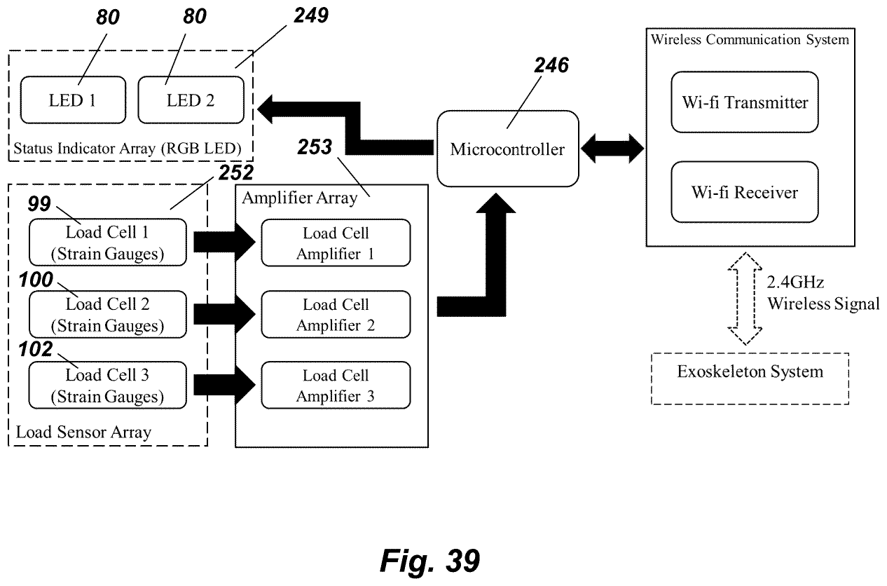

Referring to FIG. 39, it shows a close-up view of the internal components of the end-effector electronics 222 in design 2 of end-effectors 206, 208. End-effector design 2 is shown in FIG. 29. The end-effector electronics 222 consists of microcontroller 246, load sensor array 252 (consisting of load cell 1 99, load cell 2 100, and load cell 3 102), amplifier array 253 (consisting of load cell amplifiers 1, 2, 3 for load cell 1 99, load cell 2 100, load cell 3 102 respectively), status indicator array (RGB LED) 249 (consisting of LED 1 80 and LED 2 80), and wireless communication system (consisting of a Wi-Fi transmitter & receiver). Status indicator array (RGB LED) 249 consisting of LED 1 80 and LED 2 80 are electrically connected to microcontroller 246. Load sensor array 252 is electrically connected to the amplifier array 253. Load cell 1 99 in load sensor array 252 is electrically connected to load cell amplifier 1 in the amplifier array 253. Load cell 2 100 in load sensor array 252 is electrically connected to load cell amplifier 2 in amplifier array 253. Load cell 3 102 in load sensor array 252 is electrically connected to load cell amplifier 3 in amplifier array 253. Microcontroller 246 is electrically connected to the amplifier array 250 and the wireless communication system. Status indicator (LED 1 & 2) 223 consists of two RGB LEDs 80 that each give visual feedback to the user regarding important functions or information of end-effectors 206, 208 (LED output color is controlled by end-effector electronics 222). RGB LED 1 80 shows end-effectors 206, 208 overall functioning status (i.e. powering on, conducting startup sequence, system error, etc.) and status of end-effectors 206, 208 wireless connections to the exoskeleton system electronics 210 (ex. Green=Powering on/Startup Sequence, Flashing Blue=Pairing/Connecting to the End-Effectors (referring to the state of the art 802.11 technology), Solid Blue=All End-Effectors Connected, Red=Critical Error, etc.). RGB LED 2 80 shows the exoskeleton's battery level (ex. Green=100−75%, Yellow=74−50%, Orange=49−25%, Red=24−10%, Flashing Red=less than 10% etc.). Load cells 1, 2 and 3 (parts 99, 100, 102 respectively) are integrated into the user hand coupler 228, cable mount 230, and load coupler 232 respectively in end-effectors 206, 208. Load cell 2 100 in cable mount 230 is interacted with by tension forces placed on cables 202, 204 due to external forces (i.e., cable actuation system 212, user, weight of load, etc.). Load cell 3 102 in load coupler 232 is interacted directly by the weight of the load. Load cell 1 99 in the user hand coupler 228 is interacted with by external forces due to tension in cables 202, 204, weight of load, and forces applied by the user. Load cell 1 (integrated in user hand coupler 228) 99 measures forces placed directly on the user's right and left hands, load cell 2 (integrated in cable mount 230) 100 measures tensional forces placed on the end-effectors 206, 208, and load cell 3 (integrated in load coupler 232) 102 measures forces placed directly on end-effectors 206, 208. The user can indicate to lift, lower, or hold a load due to the exoskeleton system electronics 210 automatically detecting whether the user is trying to either lift, lower, or hold a load based on sensor values from load cells 1, 2, and 3 (parts 99, 100, 102 integrated in user hand coupler 228, cable mount 230, and load coupler 232 respectively). The automatic detection is achieved by the user indirectly interacting with load cells 1, 2, 3 by; raising end-effectors 206, 208 to indicate to lift; pulling down on end-effectors 206, 208 to indicate to lower; keeping end-effectors 206, 208 stationary to indicate to hold. Forces applied on load cells 1, 2, and 3 result in a change in resistance. Load cell amplifiers 1, 2, and 3 in the amplifier array 253 convert and amplify small changes in resistance of load cells 1, 2, 3 (due to external forces on the load cells, i.e. from the user, weight of load, etc.) into a measurable voltage that microcontroller 246 can detect and measure. The microcontroller 246 controls the wireless communication system directly by sending Wi-Fi packets (consisting of the measured analog voltages of load cells 1, 2, 3) to the exoskeleton system microcontroller 236.

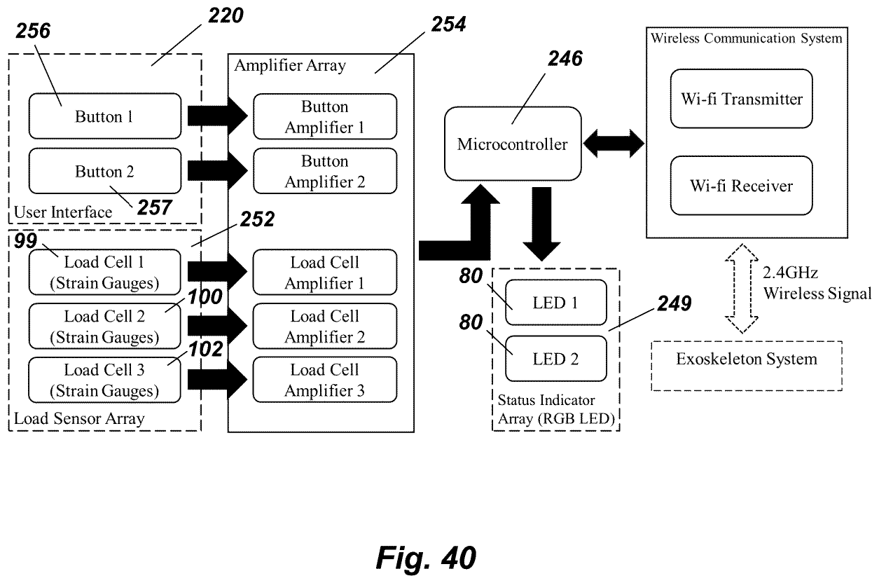

Referring to FIG. 40, it shows a close-up view of the internal components of the end-effector electronics 222 in design 3 of end-effectors 206, 208. End-effector design 3 is shown in FIG. 30. Design 3 incorporates sensors from both end-effector designs 1 & 2 (user interface 220 (consisting of force sensitive button 1 256 & force sensitive button 2 257) and load sensor array 252 (consisting of load cell 1 99, load cell 2 100, and load cell 3 102)). Design 3 can switch between/operate as either design 1 or design 2 (designs 1 & 2 are shown in FIGS. 28 and 29 respectively). The end-effector electronics 222 consists of microcontroller 246, user interface 220 (consisting of force sensitive button 1 256 & force sensitive button 2 257), load sensor array 252 (consisting of load cell 1 99, load cell 2 100, and load cell 3 102), amplifier array 254 (consisting of button amplifiers 1 & 2 (for button 1 256 and button 2 257 respectively) and load cell amplifiers 1, 2, 3 (for load cell 1 99, load cell 2 100, and load cell 3 102)), status indicator array (RGB LED) 249 (consisting of LED 1 80 and LED 2 80), and wireless communication system (consisting of a Wi-Fi transmitter & receiver). Status indicator array (RGB LED) 249 consisting of LED 1 80 & LED 2 80 are electrically connected to microcontroller 246. User interface 220 is electrically connected to the amplifier array 254. Button 1 256 in the user interface 220 is electrically connected to button amplifier 1 in the amplifier array 254. Button 2 257 in the user interface 220 is electrically connected to button amplifier 2 in the amplifier array 254. Load sensor array 252 is electrically connected to the amplifier array 254. Load cell 1 99 in the load sensor array 252 is electrically connected to load cell amplifier 1 in the amplifier array 254. Load cell 2 100 in load sensor array 252 is electrically connected to load cell amplifier 2 in the amplifier array 254. Load cell 3 102 in load sensor array 252 is electrically connected to load cell amplifier 3 in amplifier array 254. Microcontroller 246 is electrically connected to the amplifier array 250 and the wireless communication system. Load cells 1, 2 and 3 (parts 99, 100, 102 respectively) are integrated into the user hand coupler 228, cable mount 230, and load coupler 232 respectively in end-effectors 206, 208. Buttons 1 & 2 (parts 256 and 257 respectively) are force sensitive resistive sensors and make up the user interface 220 on end-effectors 206, 208. The microcontroller 246 controls the wireless communication system directly by sending Wi-Fi packets (consisting of the measured analog voltages of buttons 1 & 2 and load cells 1, 2, 3) to the exoskeleton system microcontroller 236. Status indicator (LED 1 & 2) 223 consists of two RGB LEDs 80 that each give visual feedback to the user regarding important functions or information of end-effectors 206, 208 (LED output color is controlled by end-effector electronics 222). RGB LED 1 80 shows end-effectors 206, 208 overall functioning status (i.e. powering on, conducting startup sequence, system error, etc.) and status of end-effectors 206, 208 wireless connections to the exoskeleton system electronics 210 (ex. Green=Powering on/Startup Sequence, Flashing Blue=Pairing/Connecting to the End-Effectors (referring to the state of the art 802.11 technology), Solid Blue=All End-Effectors Connected, Red=Critical Error, etc.). RGB LED 2 80 shows the exoskeleton's battery level (ex. Green=100−75%, Yellow=74−50%, Orange=49−25%, Red=24−10%, Flashing Red=less than 10% etc.).

In operation as end-effector 206, 208 design 1, the user can indicate for the exoskeleton (consisting of backpack harness 200, exoskeleton system 198, and right & left end-effectors 206, 208) to lift, lower, or hold a load by interacting with user interface 220 (consisting of force sensitive button 1 256 & force sensitive button 2 257) on end-effectors 206, 208 using the right and left hands. Forces applied on buttons 1 & 2 (parts 256 and 257 respectively) result in a change in resistance. Button amplifiers 1 & 2 in the amplifier array 254 convert and amplify small changes in resistance of buttons 1 & 2 (due to external forces on the force sensitive buttons 1 & 2 from the user) into a measurable voltage that microcontroller 246 can detect and measure. Microcontroller 246 controls the wireless communication system directly by sending Wi-Fi (consisting of the measured analog voltages of buttons 1 & 2 and load cells 1, 2, 3) to the exoskeleton system microcontroller 236.

In operation as end-effector 206, 208 design 2, the user can indicate to lift, lower, or hold a load due to the exoskeleton system electronics 210 automatically detecting whether the user is trying to either lift, lower, or hold a load based on sensor values from load cells 1, 2, and 3 (parts 99, 100, 102 integrated in user hand coupler 228, cable mount 230, and load coupler 232 respectively). Load cell 2 100 in cable mount 230 is interacted with by tension forces placed on cables 202, 204 due to external forces (i.e., cable actuation system 212, user, weight of load, etc.). Load cell 3 102 in load coupler 232 is interacted directly by the weight of the load. Load cell 1 99 in the user hand coupler 228 is interacted with by external forces due to tension in cables 202, 204, weight of load, and forces applied by the user. Load cell 1 (integrated in user hand coupler 228) 99 measures forces placed directly on the user's right and left hands, load cell 2 (integrated in cable mount 230) 100 measures tensional forces placed on the end-effectors 206, 208, and load cell 3 (integrated in load coupler 232) 102 measures forces placed directly on end-effectors 206, 208. The automatic detection is achieved by the user indirectly interacting with load cells 1, 2, 3 (parts 99, 100, 102 respectively) by; raising end-effectors 206, 208 to indicate to lift; pulling down on end-effectors 206, 208 to indicate to lower; keeping end-effectors 206, 208 stationary to indicate to hold. Forces applied on load cells 1, 2, and 3 (parts 99, 100, 102 respectively) result in a change in resistance. Load cell amplifiers 1, 2, and 3 in the amplifier array 254 convert and amplify small changes in resistance of load cells 1, 2, 3 (due to external forces on the load cells, i.e. from the user, weight of load, etc.) into a measurable voltage that microcontroller 246 can detect and measure. Microcontroller 246 controls the wireless communication system directly by sending Wi-Fi (consisting of the measured analog voltages of buttons 1 & 2 and load cells 1, 2, 3) to the exoskeleton system microcontroller 236.

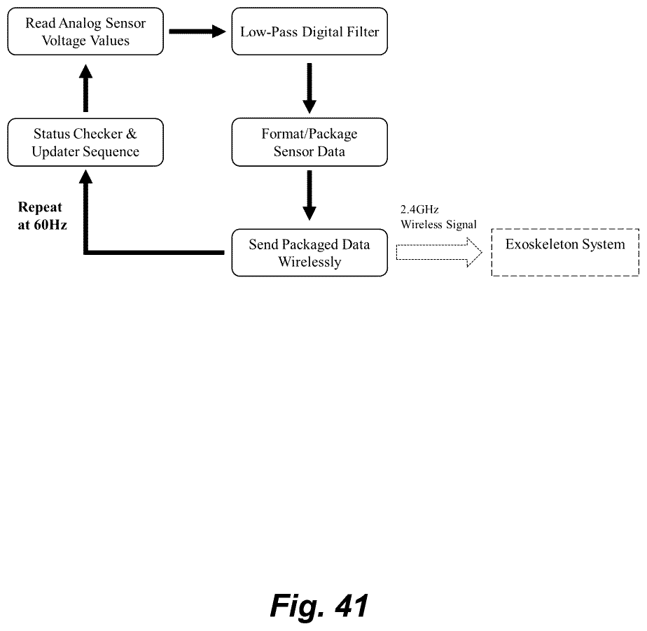

Referring to FIG. 41, it shows a high-level view of the code used to program microcontroller 246 in designs 1, 2, & 3 of end-effectors 206, 208. The structure of the code is the same for designs 1, 2, & 3 of end-effectors 206, 208. The sensor processing details change in end-effector designs 1, 2, & 3 (end-effector designs 1, 2, and 3 are shown in FIGS. 28, 29, and 30 respectively).

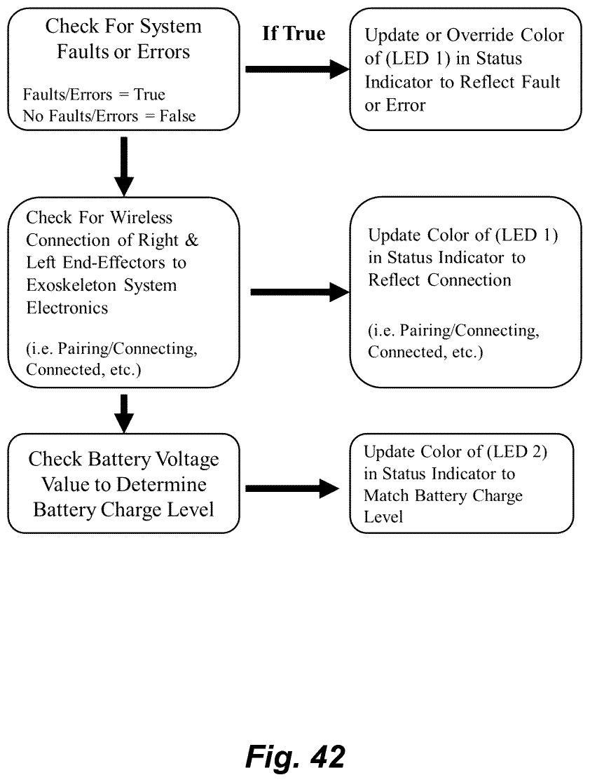

The overview of the code for end-effector design 1 (shown in FIG. 28) is to take user inputs from the user interface 220 (consisting of force sensitive button 1 256 & force sensitive button 2 257) and send them to microcontroller 236 in exoskeleton system electronics 210. The logistics of the code are as follows; conduct status checker & updater sequence (to update the color of LED 1 80 & LED 2 80 in status indicator 223 corresponding to system faults/errors, end-effector 206, 208 wireless connection status with exoskeleton system electronics 210, and battery charge level percentage)(status checker & updater sequence is shown in FIG. 42); read analog voltage values from buttons 1 & 2 (parts 256 and 257 respectively) from user interface 220; pass the analog voltage values of buttons 1 & 2 through a low-pass digital filter (to filter out high-frequency disturbances in voltages of buttons 1 & 2 due to noise, temperature, etc.); format/package the filtered voltage values of buttons 1 & 2 to be ready for wireless transmission to the exoskeleton system microcontroller 236; send the packaged voltage values of buttons 1 & 2 to the exoskeleton system microcontroller 236; then repeat the above mentioned logistics for end-effector design 1 at a 60 Hz rate.

The overview of the code for end-effector design 2 (shown in FIG. 29) is to take user inputs from the load cell array 252 (consisting of load cell 1 99, load cell 2 100, and load cell 3 102) and send them to microcontroller 236 in exoskeleton system electronics 210. The logistics of the code are as follows; conduct status checker & updater sequence (to update the color of LED 1 80 and LED 2 80 in status indicator 223 corresponding to system faults/errors, end-effector 206, 208 wireless connection status with exoskeleton system electronics 210, and battery charge level percentage)(status checker & updater sequence is shown in FIG. 42); read analog voltage values from load cells 1, 2, 3 (parts 99, 100, 102 respectively) from load cell array 252; pass the analog voltage values of load cells 1, 2, 3 through a low-pass digital filter (to filter out high-frequency disturbances in voltages of buttons 1 & 2 and load cells 1, 2, 3 due to noise, temperature, etc.); format/package the filtered voltage values of load cells 1, 2, 3 to be ready for wireless transmission to the exoskeleton system microcontroller 236; send the packaged voltage values of load cells 1, 2, 3 to the exoskeleton system microcontroller 236; then repeat the above mentioned logistics for end-effector design 2 at a 60 Hz rate.

The overview of the code for end-effector design 3 (shown in FIG. 30) is to take user inputs from the user interface 220 (consisting of force sensitive button 1 256 & force sensitive button 2 257) and load cell array 252 (consisting of load cell 1 99, load cell 2 100, and load cell 3 102) and send them to microcontroller 236 in exoskeleton system electronics 210. The logistics of the code are as follows; conduct status checker & updater sequence (to update the color of LED 1 80 and LED 2 80 in status indicator 223 corresponding to system faults/errors, end-effector 206, 208 wireless connection status with exoskeleton system electronics 210, and battery charge level percentage) (status checker & updater sequence is shown in FIG. 42); read analog voltage values from buttons 1 & 2 (parts 256 and 257 respectively) from user interface 220 and load cells 1, 2, 3 (parts 99, 100, 102 respectively) from load cell array 252; pass the analog voltage values of buttons 1 & 2 and load cells 1, 2, 3 through a low-pass digital filter (to filter out high-frequency disturbances in voltages of buttons 1 & 2 and load cells 1, 2, 3 due to noise, temperature, etc.); format/package the filtered voltage values of buttons 1 & 2 and load cells 1, 2, 3 to be ready for wireless transmission to the exoskeleton system microcontroller 236; send the packaged voltage values of buttons 1 & 2 and load cells 1, 2, 3 to the exoskeleton system microcontroller 236; then repeat the above mentioned logistics for end-effector design 3 at a 60 Hz rate.

Referring to FIG. 42, it shows a close-up view of the status checker & updater sequence used in the code to program microcontroller 246 in end-effector electronics 222 for right & left end-effectors 206, 208. The overview of the code is to update LED 1 80 & LED 2 80 in status indicator 223 corresponding to system faults/errors, end-effector 206, 208 wireless connection status with exoskeleton system electronics 210, and battery charge level percentage. Status indicator 223 consists of two RGB LEDs 80 that each give visual feedback to the user regarding important functions or information of end-effectors 206, 208 (LED output color is controlled by end-effector electronics 222). RGB LED 1 80 shows end-effectors 206, 208 overall functioning status (i.e. powering on, conducting startup sequence, system error, etc.) and status of end-effectors 206, 208 wireless connections to the exoskeleton system electronics 210 (ex. Green=Powering on/Startup Sequence, Flashing Blue=Pairing/Connecting to the End-Effectors (referring to the state of the art 802.11 technology), Solid Blue=All End-Effectors Connected, Red=Critical Error, etc.). RGB LED 2 80 shows the exoskeleton's battery level (ex. Green=100−75%, Yellow=74−50%, Orange=49−25%, Red=24−10%, Flashing Red=less than 10% etc.). The logistics of the code are as follows; check for system faults or errors; if faults/errors are found, then update or override color of LED 1 to reflect a fault or error (i.e. to display to the user any errors or faults); check for the wireless connection status (referring to the state of the art 802.11 technology) of end-effectors 206, 208 to exoskeleton system electronics 210 (i.e. pairing/connecting, fully connected, unable to connect, etc.); update color of LED 1 to reflect the connection status of end-effectors 206, 208 to exoskeleton system electronics 210 (i.e. to display to the user the connection status); check battery voltage value to determine battery charge level percentage; then update color of LED 2 to match/indicate the battery charge level percentage (i.e. to display to the user the battery percentage).

Referring to FIG. 43, it shows a general overview of the user operating modes used to control the exoskeleton (consisting of backpack harness 200, exoskeleton system 198, and right & left end-effectors 206, 208) to lift, lower, or hold a load by user interaction with sensors from either user interface 220 (consisting of force sensitive button 1 256 & force sensitive button 2 257) in end-effector designs 1 & 3 or from load sensor array 252 (consisting of load cell 1 99, load cell 2 100, and load cell 3 102) in end-effector designs 2 & 3. End-effector designs 1, 2, 3 are shown in FIGS. 28, 29, and 30 respectively. The connections (indicated by the arrows) show how each mode can switch and transition between each other only when used with end-effector design 3. Manual Operation mode, when active, uses sensor values only from user interface 220 (consisting of force sensitive button 1 256 & force sensitive button 2 257) to control the exoskeleton (consisting of backpack harness 200, exoskeleton system 198, and right & left end-effectors 206, 208) to assist in lifting, lowering, or holding a load. Automatic Operation mode, when active, uses sensor values only from load sensor array 252 (consisting of load cell 1 99, load cell 2 100, and load cell 3 102) to control the exoskeleton (consisting of backpack harness 200, exoskeleton system 198, and right & left end-effectors 206, 208) to assist in lifting, lowering, or holding a load. The user operating modes can switch and transition between each other (only when used with end-effector design 3) by the user interacting with buttons 1 & 2 (parts 256 and 257 respectively) to cause button 1 sensor value to be greater than 0 and button 2 sensor value to be greater than 0 for more than 5 seconds (the timing can be modified to be longer or shorter than the indicated 5 seconds).

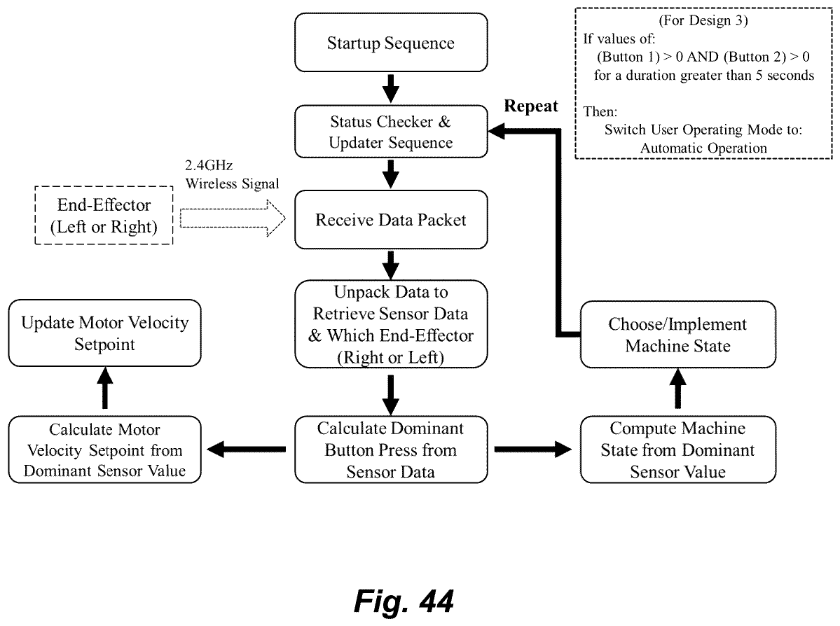

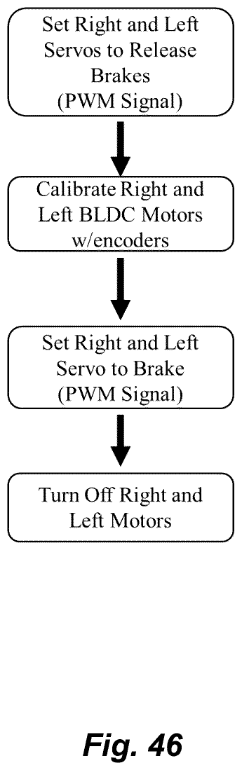

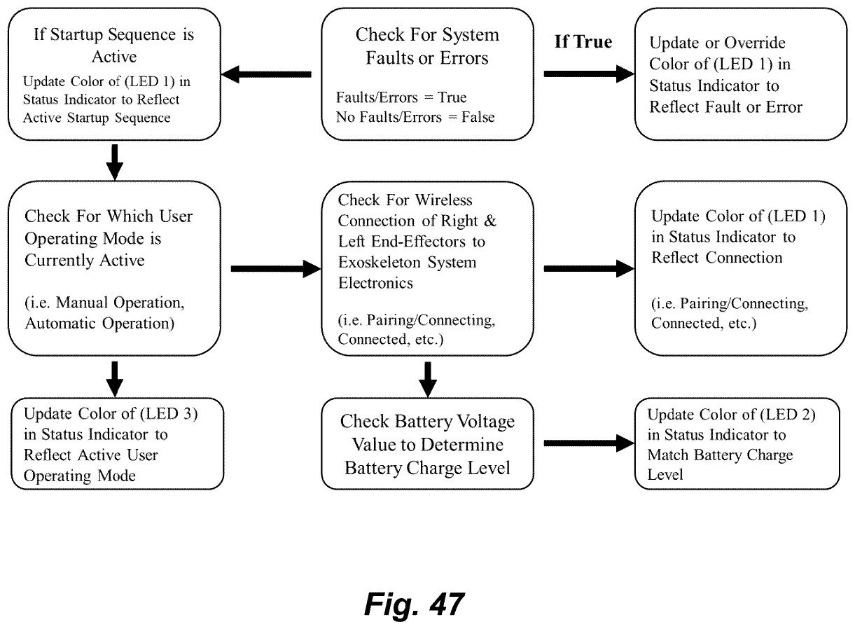

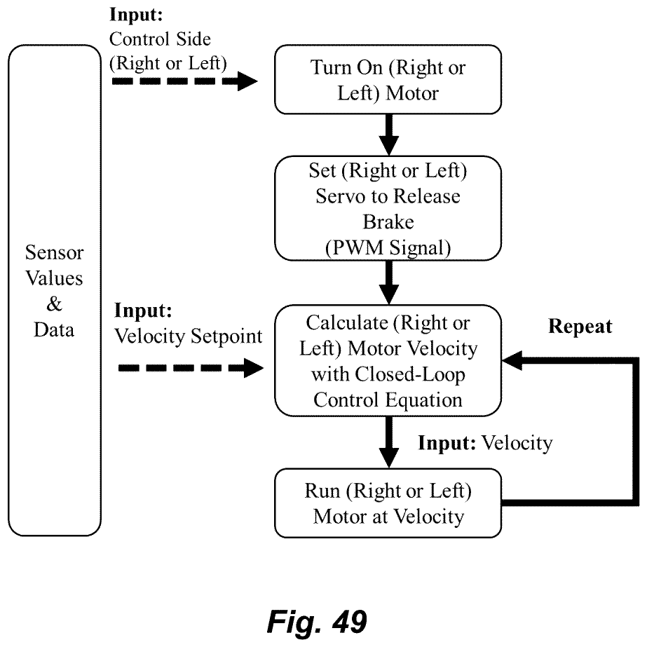

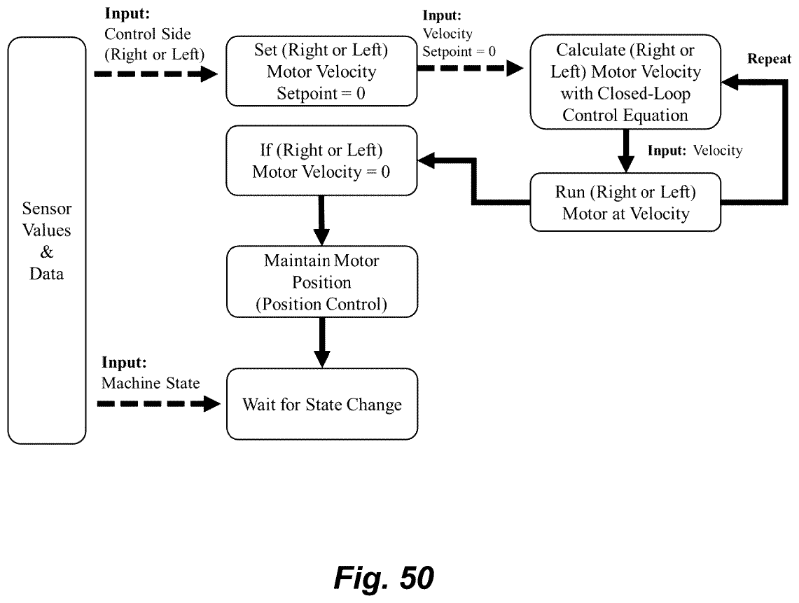

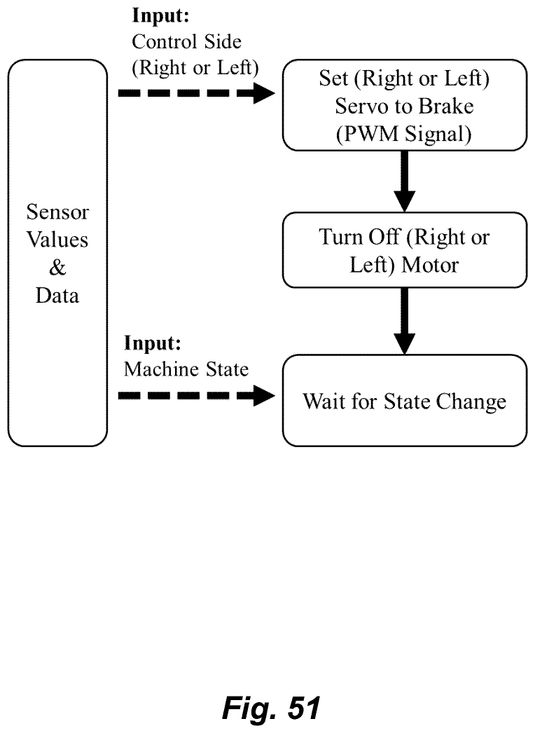

Referring to FIG. 44, it shows a high-level view of the code for manual operation (a user operating mode shown in FIG. 43) used to program microcontroller 236 in exoskeleton system electronics 210 in designs 1 & 3 of end-effectors 206, 208 (designs 1 & 3 are shown in FIGS. 28 and 30 respectively). Exoskeleton system microcontroller 236 drives and commands the cable actuation system 212 and braking system 214 to lift, lower, or hold a load based on the sensor values from buttons 1 & 2 (parts 256 and 257 in user interface 220). The cable actuation system 212 is used to lift or lower a load by winding or unwinding cables 202, 204 through actuating the right & left cable spools 216. The braking system (disc brake) 214 is used to apply a brake on the right & left cable spools 216 that stops the load from being lowered by unwanted external means (i.e., weight of load, user, etc.). Status indicator (LED 1, 2, 3) 211 consists of three RGB LEDs 80 that each give visual feedback to the user regarding important functions or information of the exoskeleton (LED output color is controlled by exoskeleton system electronics 210). RGB LED 1 80 shows the exoskeleton's overall functioning status (i.e. powering on, conducting startup sequence, system error, etc.) and status of end-effectors 206, 208 wireless connections to the exoskeleton system electronics 210 (ex. Green=Powering on/Startup Sequence, Flashing Blue=Pairing/Connecting to the End-Effectors (referring to the state of the art 802.11 technology), Solid Blue=All End-Effectors Connected, Red=Critical Error, etc.). RGB LED 2 80 shows the exoskeleton's battery level (ex. Green=100−75%, Yellow=74−50%, Orange=49−25%, Red=24−10%, Flashing Red=less than 10% etc.). RGB LED 3 80 shows which operating mode (shown in FIG. 43) is currently being used for commanding the exoskeleton to lift, lower, or hold a load (ex. Orange=Manual Operation Mode, Blue=Automatic Operation Mode). The overview of the code is to receive the wirelessly sent user inputs from the user interface 220 (consisting of force sensitive button 1 256 & force sensitive button 2 257) from end-effectors 206, 208 to control the cable actuation system 212 (which includes the right & left BLDC motors 240, 238) and the braking system 214 (which includes the right & left servos 244, 242). The logistics of the code are as follows; conduct a startup sequence (calibrate the right & left BLDC motors with encoders) once per startup/power cycle (startup sequence shown in FIG. 46); conduct status checker & updater sequence (to update LEDs 1, 2, 3 in status indicator 241 corresponding to system faults/errors, end-effector 206, 208 wireless connection status with exoskeleton system electronics 210, battery charge level percentage, and which operating mode (discussed in FIG. 43) is currently active)(status checker & updater sequence is shown in FIG. 47); receive the wirelessly sent user input voltage values of buttons 1 & 2 (parts 256 and 257 respectively) from the user interface 220 in end-effectors 206, 208; unpack and read the wirelessly sent voltage values of buttons 1 & 2 and determine which end-effector (right end-effector 208 or left end-effector 206) the button 1 & 2 voltage values came from; calculate the dominant button press (either button 1 or button 2); calculate motor velocity setpoint (to be used to control the speed of the right & left BLDC motors) based from the voltage values from the dominantly pressed button (either button 1 or button 2); update the motor velocity setpoint value (used in FIG. 49); from the dominantly pressed button voltage value (either button 1 or button 2), compute the machine state (active state, deactivate state, or idle state) used in determining the control of the right & left BLDC motors (in cable actuation system 212) and the right & left servos (in braking system 214); then choose and implement the computed machine state (used in FIGS. 50 and 51); then repeat the above mentioned logistics excluding the startup sequence. The active user operating mode (shown in FIG. 43) can switch from manual operation mode to automatic operation mode (only in end-effector design 3) by the user interacting with buttons 1 & 2 (parts 256 and 257 respectively) to cause button 1 sensor value to be greater than 0 and button 2 sensor value to be greater than 0 for more than 5 seconds (the timing can be modified to be longer or shorter than the indicated 5 seconds).

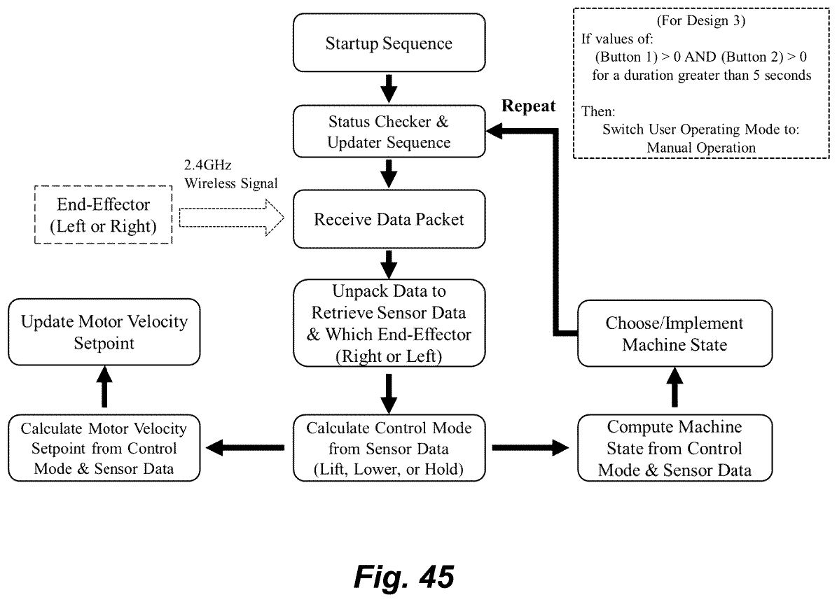

Referring to FIG. 45, it shows a high-level view of the code for automatic operation (a user operating mode shown in FIG. 43) used to program microcontroller 236 in exoskeleton system electronics 210 in designs 2 & 3 of end-effectors 206, 208 (designs 2 & 3 are shown in FIGS. 29 and 30 respectively). Exoskeleton system microcontroller 236 drives and commands the cable actuation system 212 and braking system 214 to lift, lower, or hold a load based on the sensor values from load cells 1, 2, and 3 (parts 99, 100, 102 respectively) in load sensor array 252. The cable actuation system 212 is used to lift or lower a load by winding or unwinding cables 202, 204 through actuating the right & left cable spools 216. The braking system (disc brake) 214 is used to apply a brake on the right & left cable spools 216 that stops the load from being lowered by unwanted external means (i.e., weight of load, user, etc.). Status indicator (LED 1, 2, 3) 211 consists of three RGB LEDs 80 that each give visual feedback to the user regarding important functions or information of the exoskeleton (LED output color is controlled by exoskeleton system electronics 210). RGB LED 1 80 shows the exoskeleton's overall functioning status (i.e. powering on, conducting startup sequence, system error, etc.) and status of end-effectors 206, 208 wireless connections to the exoskeleton system electronics 210 (ex. Green=Powering on/Startup Sequence, Flashing Blue=Pairing/Connecting to the End-Effectors (referring to the state of the art 802.11 technology), Solid Blue=All End-Effectors Connected, Red=Critical Error, etc.). RGB LED 2 80 shows the exoskeleton's battery level (ex. Green=100−75%, Yellow=74−50%, Orange=49−25%, Red=24−10%, Flashing Red=less than 10% etc.). RGB LED 3 80 shows which operating mode (shown in FIG. 43) is currently being used for commanding the exoskeleton to lift, lower, or hold a load (ex. Orange=Manual Operation Mode, Blue=Automatic Operation Mode). The overview of the code is to receive the wirelessly sent user inputs from load cells 1, 2, and 3 (parts 99, 100, 102 integrated in user hand coupler 228, cable mount 230, and load coupler 232 respectively) from end-effectors 206, 208 and control the cable actuation system 212 (which includes the right & left BLDC motors 240, 238) and the braking system 214 (which includes the right & left servos 244, 242). The logistics of the code are as follows; conduct a startup sequence (calibrate the right & left BLDC motors with encoders) once per startup/power cycle (startup sequence shown in FIG. 46); conduct status checker & updater sequence (to update LEDs 1, 2, 3 in status indicator 241 corresponding to system faults/errors, end-effector 206, 208 wireless connection status with exoskeleton system electronics 210, battery charge level percentage, and which operating mode (discussed in FIG. 43) is currently active)(status checker & updater sequence is shown in FIG. 47); receive the wirelessly sent user input voltage values of load cells 1, 2, and 3 (parts 99, 100, 102 respectively) from end-effectors 206, 208; unpack and read the wirelessly sent voltage values of load cells 1, 2, and 3 and determine which end-effector (right end-effector 208 or left end-effector 206) the load cell voltage values came from; calculate the control mode (lift, lower, or hold) from load cell 1, 2, and 3 voltage values; calculate motor velocity setpoint (to be used to control the speed of the right & left BLDC motors) based from the calculated control mode and voltage values from load cells 1, 2, and 3; update the motor velocity setpoint value (used in FIG. 49); from the voltage values from load cells 1, 2, and 3, compute the machine state (active state, deactivate state, or idle state) used in determining the control of the right & left BLDC motors (in cable actuation system 212) and the right & left servos (in braking system 214); then choose and implement the computed machine state (used in FIGS. 50 and 51); then repeat the above mentioned logistics excluding the startup sequence. The active user operating mode (shown in FIG. 43) can switch from automatic operation mode to manual operation mode (only in end-effector design 3) by the user interacting with buttons 1 & 2 (parts 256 and 257 respectively in user interface 220) to cause button 1 sensor value to be greater than 0 and button 2 sensor value to be greater than 0 for more than 5 seconds (the timing can be modified to be longer or shorter than the indicated 5 seconds).

Referring to FIG. 46, it shows a close-up view of the startup sequence used in the code to program microcontroller 236 in exoskeleton system electronics 210. Exoskeleton system microcontroller 236 drives and commands the cable actuation system 212 and braking system 214 to lift, lower, or hold a load based on the sensor values from buttons 1 & 2. The cable actuation system 212 is used to lift or lower a load by winding or unwinding cables 202, 204 through actuating the right & left cable spools 216. The braking system (disc brake) 214 is used to apply a brake on the right & left cable spools 216 that stops the load from being lowered by unwanted external means (i.e., weight of load, user, etc.). The overview of the code is to calibrate the right & left BLDC motors 240, 238 (in cable actuation system 212) and apply the brakes using the right & left servos 244, 242 (in braking system 214). The logistics of the code are as follows; set the right & left servos to release the brake to allow for actuation of the right & left BLDC motors 240, 238; calibrate the right & left BLDC motors 240, 238 with the encoder position; set the right & left servos 244, 242 to apply the brake to stop end-effectors 206, 208, cables 202, 204, and the right & left cable spools 216 from lowering/unreeling from unwanted means (i.e., weight of load, user, etc.); turn off the right & left BLDC motors 240, 238 to save power while the braking system 214 is actively applying a brake (to achieve higher power efficiency and longer battery life).

Referring to FIG. 47, it shows a close-up view of the status checker & updater sequence used in the code to program microcontroller 236 in exoskeleton system electronics 210. The overview of the code is to update LEDs 1, 2, 3 in status indicator 241 corresponding to system faults/errors, end-effector 206, 208 wireless connection status with exoskeleton system electronics 210, battery charge level percentage, and which operating mode (discussed in FIG. 43) is currently being used for commanding the exoskeleton to lift, lower, or hold a load (ex. Orange=Manual Operation Mode, Blue=Automatic Operation Mode). Status indicator 211 consists of three RGB LEDs 80 that each give visual feedback to the user regarding important functions or information of the exoskeleton (LED output color is controlled by exoskeleton system electronics 210). RGB LED 1 80 shows the exoskeleton's overall functioning status (i.e. powering on, conducting startup sequence, system error, etc.) and status of end-effectors 206, 208 wireless connections to the exoskeleton system electronics 210 (ex. Green=Powering on/Startup Sequence, Flashing Blue=Pairing/Connecting to the End-Effectors (referring to the state of the art 802.11 technology), Solid Blue=All End-Effectors Connected, Red=Critical Error, etc.). RGB LED 2 80 shows the exoskeleton's battery level (ex. Green=100−75%, Yellow=74−50%, Orange=49−25%, Red=24−10%, Flashing Red=less than 10% etc.). RGB LED 3 80 shows which operating mode (shown in FIG. 43) is currently being used for commanding the exoskeleton to lift, lower, or hold a load (ex. Orange=Manual Operation Mode, Blue=Automatic Operation Mode). The logistics of the code are as follows; check for system faults or errors; if faults/errors are found, then update or override color of LED 1 to reflect a fault or error (i.e. to display to the user any errors or faults); if startup sequence is active, then update color of LED 1 to reflect the active startup sequence (i.e. to display to the user the active startup sequence); check for which user operating mode is currently active (shown in FIG. 43); then update color of LED 3 to reflect the active user operating mode (i.e. to display to the user the active user operating mode); check for the wireless connection status (referring to the state of the art 802.11 technology) of end-effectors 206, 208 to exoskeleton system electronics 210 (i.e. pairing/connecting, fully connected, unable to connect, etc.); update color of LED 1 to reflect the connection status of end-effectors 206, 208 to exoskeleton system electronics 210 (i.e. to display to the user the connection status); check battery voltage value to determine battery charge level percentage; update color of LED 2 to match/indicate the battery charge level percentage (i.e. to display to the user the battery percentage).

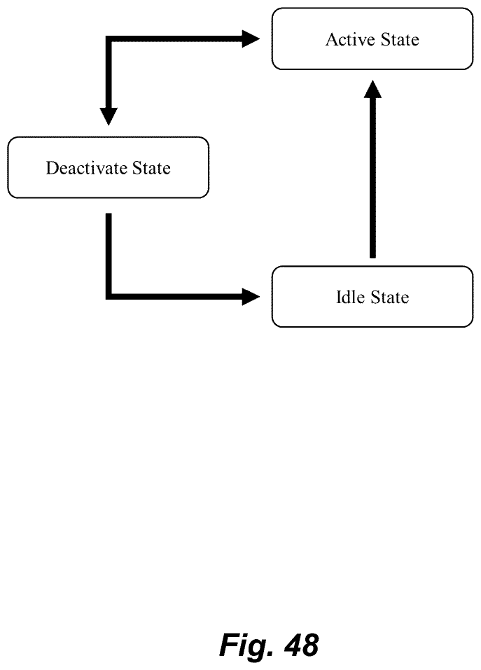

Referring to FIG. 48, it shows a general overview of the state machine used in the code to program microcontroller 236 in exoskeleton system electronics 210. The state machine consists of three states; active state (runs the right & left BLDC motors 240, 238 in cable actuation system 212), deactivate state (applies brake using the right & left BLDC motors 240, 238 in cable actuation system 212), and idle state (applies brake using the right & left servos 244, 242 in braking system 214). The active state operates running the right & left BLDC motors 240, 238 (in cable actuation system 212) at speeds indicated by velocity setpoint calculated from the exoskeleton system microcontroller 236 code. The deactivate state brings the right & left BLDC motors 240, 238 speed to zero revolutions per minute (rpm) and maintains the motors current position (position control) until a state change. The idle state operates running the right & left servos 244, 242 (in braking system 214) and turns off the right & left BLDC motor 240, 238 until a state change. How each state can switch/transition between each other are as follows; the active state can transition only to the deactivate state (depending on the commanded state calculated from the exoskeleton system microcontroller 236 code); the deactivate state can transition to the active state or the idle state (depending on the commanded state calculated from the exoskeleton system microcontroller 236 code); the idle state can transition only to the active state (depending on the commanded state calculated from the exoskeleton system microcontroller 236 code).

Referring to FIG. 49, it shows a close-up view of the code of the active state (a state from the state machine in FIG. 48) used in the code to program microcontroller 236 in exoskeleton system electronics 210. The overview of the active state code is operating and running the right & left BLDC motors 240, 238 (in cable actuation system 212) at speeds indicated by velocity setpoint calculated from the exoskeleton system microcontroller 236 code. The inputs to the code are control side (right or left side) and velocity setpoint. The control side (right or left side) comes from the exoskeleton system microcontroller 236 code and is determined by which end-effector (right or left end-effector 206, 208) sent the sensor data (buttons 1 or 2 (parts 256 or 257 respectively) in designs 1 & 3 of end-effectors 206, 208; or load cells 1, 2, or 3 (parts 99, 100, 102 respectively) in designs 2 & 3 of end-effectors 206, 208). The velocity setpoint value comes from the exoskeleton system microcontroller 236 code and is determined by the calculation from the sensor data (buttons 1 or 2 (parts 256 or 257 respectively) in designs 1 & 3 of end-effectors 206, 208; or load cells 1, 2, or 3 (parts 99, 100, 102 respectively). The logistics of the code are as follows; turn on either the right or left BLDC motor 240, 238 (indicated by the control side); release the brake using the right or left servo 244, 242 (indicated by the control side); control and calculate the motor velocity for either the right or left BLDC motor 240, 238 (indicated by the control side) using a closed-loop control equation (for smooth accelerations & decelerations in motor velocity reducing sudden changes in speed) with the setpoint indicated by velocity setpoint from the exoskeleton system microcontroller 236 code; repeat the control and calculation of the motor velocity for either the right or left BLDC motor 240, 238 (indicated by the control side) until a state change (from commanded state calculated from the exoskeleton system microcontroller 236 code).

Referring to FIG. 50, it shows a close-up view of the code of the deactivate state (a state from the state machine in FIG. 48) used in the code to program microcontroller 236 in exoskeleton system electronics 210. The overview of the deactivate state code is bringing the right & left BLDC motors 240, 238 (in cable actuation system 212) speed to zero revolutions per minute (rpm) and maintain the motors current position (position control) to apply brake on the right & left cable spools 216 using the right & left BLDC motors 240, 238 until a state change. The inputs to the code are control side (right or left side) and machine state. The control side (right or left side) comes from the exoskeleton system microcontroller 236 code and is determined by which end-effector (right or left end-effector 206, 208) sent the sensor data (buttons 1 or 2 (parts 256 or 257 respectively) in designs 1 & 3 of end-effectors 206, 208; or load cells 1, 2, or 3 (parts 99, 100, 102 respectively). The machine state comes from the exoskeleton system microcontroller 236 code and is determined by the calculation from the sensor data (buttons 1 or 2 (parts 256 or 257 respectively) in designs 1 & 3 of end-effectors 206, 208; or load cells 1, 2, or 3 (parts 99, 100, 102 respectively). The logistics of the code are as follows; set the right or left BLDC motor 240, 238 (indicated by the control side) velocity setpoint to zero; control and calculate the motor velocity for either the right or left BLDC motor 240, 238 (indicated by the control side) using a closed-loop control equation (for smooth accelerations & decelerations in motor velocity reducing sudden changes in speed) with the setpoint indicated by velocity setpoint equaling zero; once the right or left BLDC motor 240, 238 (indicated by control side) is at zero velocity, maintain the position of the motor (position control) until a state change (from commanded state calculated from the exoskeleton system microcontroller 236 code).

Referring to FIG. 51, it shows a close-up view of the code of the idle state (a state from the state machine in FIG. 48) used in the code to program microcontroller 236 in exoskeleton system electronics 210. The overview of the idle state code is operating running the right & left servos (in braking system 214 to apply brake on the right & left cable spools 216 using brake discs) and turn off the right & left BLDC motor 240, 238 until a state change. The inputs to the code are control side (right or left side) and machine state. The control side (right or left side) comes from the exoskeleton system microcontroller 236 code and is determined by which end-effector (right or left end-effector 206, 208) sent the sensor data (buttons 1 or 2 (parts 256 or 257 respectively) in designs 1 & 3 of end-effectors 206, 208; or load cells 1, 2, or 3 (parts 99, 100, 102 respectively). The machine state comes from the exoskeleton system microcontroller 236 code and is determined by the calculation from the sensor data (buttons 1 or 2 (parts 256 or 257 respectively) in designs 1 & 3 of end-effectors 206, 208; or load cells 1, 2, or 3 (parts 99, 100, 102 respectively). The logistics of the code are as follows; apply the brake using the right or left servo 244, 242 (indicated by the control side); turn off either the right or left BLDC motor 240, 238 (indicated by the control side); then wait until a state change (from commanded state calculated from the exoskeleton system microcontroller 236 code).

The term “coupled” is defined as connected, although not necessarily directly, and not necessarily mechanically. The use of the word “a” or “an” when used in conjunction with the term “comprising” in the claims and/or the specification may mean “one,” but it is also consistent with the meaning of “one or more” or “at least one.” The use of the term “or” in the claims is used to mean “and/or” unless explicitly indicated to refer to alternatives only or the alternative are mutually exclusive, although the disclosure supports a definition that refers to only alternatives and “and/or.”

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a method or device that “comprises,” “has,” “includes” or “contains” one or more steps or elements, possesses those one or more steps or elements, but is not limited to possessing only those one or more elements. Likewise, a step of a method or an element of a device that “comprises,” “has,” “includes” or “contains” one or more features, possesses those one or more features, but is not limited to possessing only those one or more features. Furthermore, a device or structure that is configured in a certain way is configured in at least that way, but may also be configured in ways that are not listed.

All patents and publications mentioned in this specification are indicative of the levels of those skilled in the art to which the invention pertains. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary, and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. An exoskeleton, comprising:
an exoskeleton system spine and shoulders sub-assembly including a spine central to said spine and shoulders sub-assembly having a plurality of threaded holes, said spine having two channels allowing spine utility mount inserts to slide freely therein to align with an electronics box having interior holes to connect power cables from exoskeleton batteries to an electronics board with a BLDC motor controller and a microcontroller;
an exoskeleton system lower back sub-assembly including a lower back body having a plurality of holes corresponding said plurality of threaded holes on said spine, said lower back body constructed and arranged to secure a left BLDC motor with encoder and a right BLDC motor with encoder onto said lower back body, said left BLDC motor including a left brake unit, a left brake disk constructed and arranged to fit onto a drive shaft, and a left servo mounted to said lower back body, said right BLDC motor including a right brake unit, a right brake disk constructed and arranged to fit onto said drive shaft, and a right servo mounted to said lower back body;
a left cable spool constructed and arranged to house a left nylon cable, said left cable spool having a left spool case, a left spool case cap, and a left spool mounted to said lower back body, said left spool is mounted onto a planetary gearbox output shaft, wherein said left spool is rotated by said left BLDC motor with encoder;
a right cable spool constructed and arranged to house a right nylon cable, said right cable spool having a right spool case, a right spool case cap, and a right spool mounted to said lower back body, said right spool is mounted onto said planetary gearbox output shaft, wherein said right spool is rotated by said right BLDC motor with encoder;
a left end effector attached to said left cable spool by said left nylon cable including a left user hand coupler and a left load coupler, said left user hand coupler having a left palm side shell coupled to a left load shell forming a left end effector body, said left end effector body electronically coupled to a left status indicator, a left battery, left electronics, a first left user interface button and a second left user interface button, said left load coupler having a left ball bearing press-fit onto the left load side shell, wherein said left ball bearing allows the left load coupler to rotate to make the coupling between the object and the user more convenient; and
a right end effector attached to said right cable spool by said right nylon cable including a right user hand coupler and a right load coupler, said right user hand coupler having a right palm side shell coupled to a right load shell forming a right end effector body, said right end effector body electronically coupled to a right status indicator, a right battery, right electronics, a first right user interface button and a second right user interface button, said right load coupler having a right ball bearing press-fit onto the right load side shell, wherein said right ball bearing allows the right load coupler to rotate to make the coupling between the object and the user more convenient.

2. The exoskeleton according to claim 1, wherein a screw configuration shoulder mount plate is mounted to said spine to fasten a left shoulder bracket and a right shoulder bracket.

3. The exoskeleton according to claim 1, wherein said left BLDC motor with encoder includes a left motor body, a left motor encoder, and a motor front (left).

4. The exoskeleton according to claim 1, wherein said right BLDC motor with encoder includes a right motor body, a right motor encoder, and a motor front (right).

5. The exoskeleton according to claim 1, wherein a planetary gearbox is mounted to said left brake unit and said right brake unit constructed and arranged to reduce the amount of load for said left servo and said right servo to handle.

6. The exoskeleton according to claim 2, wherein a left Bowden case attaches to said left shoulder bracket and houses said left nylon cable.

7. The exoskeleton according to claim 2, wherein a right Bowden case attaches to said right shoulder bracket and houses said right nylon cable.

8. The exoskeleton according to claim 1, wherein said left palm side shell and left load side shell are designed to fit the contours of a human hand.

9. The exoskeleton according to claim 1, wherein said right palm side shell and right load side shell are designed to fit the contours of a human hand.

10. The exoskeleton according to claim 1, wherein said first left user interface button contours to the index finger of the user and said second left user interface button contours to the middle finger of the user, each said user interface button together form a left button shell, force sensitive button load concentrator, and a force sensitive resistor.

11. The exoskeleton according to claim 1, wherein said first right user interface button contours to the index finger of the user and said second right user interface button contours to the middle finger of the user, each said user interface button together form a right button shell, force sensitive button load concentrator, and a force sensitive resistor.

12. The exoskeleton according to claim 1, wherein said left load side shell and said right load side shell includes a first load cell constructed and arranged to take advantage of a strain gage position for sensing, wherein rotation of said left load coupler and right load coupler is limited to rotating +/−45 degrees.

13. The exoskeleton according to claim 1, wherein said left status indicator and said right status indicator includes a plurality of RGB LED lights that give visual feedback to the user regarding important functions or information of the exoskeleton.

14. The exoskeleton according to claim 1, wherein said left nylon cable and said right nylon cable are mechanically and physically connected to said left end effector and said right end effector by a left cable mount and a right cable mount, said left cable mount and said right cable mount are mechanically and physically attached to the load through said left load coupler and right load coupler.

15. The exoskeleton according to claim 1, wherein said microcontroller controls a wireless communication system having a Wi-Fi transmitter and a receiver by detecting and measuring voltages produced by said first left user interface button, said second left user interface button, said first right user interface button, and said second right user interface button and amplifying said voltages through an amplifier array, whereby said microcontroller controls said wireless communication system directly by sending said measured voltages to said microcontroller.

16. The exoskeleton according to claim 14, wherein a second load cell is mounted within said left cable mount and said right cable mount, said second load cell is interacted with by tensional forces placed on said cables due to external forces, whereby said second load cell measures cable tensional forces placed on said left and right end-effectors.

17. The exoskeleton according to claim 14, wherein a third load cell is mounted within said left load coupler and said right load coupler, said third load cell is interacted directly by the weight of the load, whereby said third load cell measures forces placed directly on said left and right end-effectors.

18. An exoskeleton, comprising:
an exoskeleton system spine and shoulders sub-assembly including a spine central to said spine and shoulders sub-assembly having a plurality of threaded holes, said spine having two channels allowing spine utility mount inserts to slide freely therein to align with an electronics box having interior holes to connect power cables from exoskeleton batteries to an electronics board with a BLDC motor controller and a microcontroller;
an exoskeleton system lower back sub-assembly including a lower back body having a plurality of holes corresponding said plurality of threaded holes on said spine, said lower back body constructed and arranged to secure a left BLDC motor with encoder having a left motor body, a left motor encoder, and a motor front (left), and a right BLDC motor with encoder having a right motor body, a right motor encoder, and a motor front (right), onto said lower back body, said left BLDC motor including a left brake unit, a left brake disk constructed and arranged to fit onto a drive shaft, and a left servo mounted to said lower back body, said right BLDC motor including a right brake unit, a right brake disk constructed and arranged to fit onto said drive shaft, and a right servo mounted to said lower back body;
a planetary gearbox secured to said lower back body and mounted to said left brake unit and said right brake unit, wherein said planetary gearbox reduces the amount of load on said left servo and said right servo;
a left cable spool constructed and arranged to house a left nylon cable, said left cable spool having a left spool case, a left spool case cap, and a left spool mounted to said lower back body, said left spool is mounted onto a planetary gearbox output shaft, wherein said left spool is rotated by said left BLDC motor with encoder;
a right cable spool constructed and arranged to house a right nylon cable, said right cable spool having a right spool case, a right spool case cap, and a right spool mounted to said lower back body, said right spool is mounted onto said planetary gearbox output shaft, wherein said right spool is rotated by said right BLDC motor with encoder;
a left end effector attached to said left cable spool by said left nylon cable including a left user hand coupler and a left load coupler, said left user hand coupler having a left palm side shell coupled to a left load shell forming a left end effector body constructed and arranged to fit the contours of a human hand, said left end effector body electronically coupled to a left status indicator, a left battery, left electronics, a first left user interface button contouring to the index finger of a user and a second left user interface button contouring to the middle finger of a user, each said left user interface button together form a left button shell, force sensitive button load concentrator, and a force sensitive resistor, and said left load coupler having a left ball bearing press-fit onto the left load side shell, wherein said left ball bearing allows the left load coupler to rotate to make the coupling between the object and the user more convenient; and
a right end effector attached to said right cable spool by said right nylon cable including a right user hand coupler and a right load coupler, said right user hand coupler having a right palm side shell coupled to a right load shell forming a right end effector body constructed and arranged to fit the contours of a human hand, said right end effector body electronically coupled to a right status indicator, a right battery, right electronics, a first right user interface button contouring to the index finger of a user and a second right user interface button contouring to the middle finger of a user, each said right user interface button together form a right button shell, force sensitive button load concentrator, and a force sensitive resistor, and said right load coupler having a right ball bearing press-fit onto the right load side shell, wherein said right ball bearing allows the right load coupler to rotate to make the coupling between the object and the user more convenient.

19. The exoskeleton according to claim 18, wherein a screw configuration shoulder mount plate is mounted to said spine to fasten a left shoulder bracket and a right shoulder bracket.

20. The exoskeleton according to claim 19, wherein a left Bowden case attaches to said left shoulder bracket and houses said left nylon cable.

21. The exoskeleton according to claim 19, wherein a right Bowden case attaches to said right shoulder bracket and houses said right nylon cable.

22. The exoskeleton according to claim 18, wherein said left load side shell and said right load side shell includes a first load cell constructed and arranged to take advantage of a strain gage position for sensing, wherein rotation of said left load coupler and right load coupler is limited to rotating +/−45 degrees.

23. The exoskeleton according to claim 18, wherein said left status indicator and said right status indicator includes a plurality of RGB LED lights that give visual feedback to the user regarding important functions or information of the exoskeleton.

24. The exoskeleton according to claim 18, wherein said left nylon cable and said right nylon cable are mechanically and physically connected to said left end effector and said right end effector by a left cable mount and a right cable mount, said left cable mount and said right cable mount are mechanically and physically attached to the load through said left load coupler and right load coupler.

25. The exoskeleton according to claim 24, wherein a second load cell is mounted within said left cable mount and said right cable mount, said second load cell is interacted with by tensional forces placed on said cables due to external forces, whereby said second load cell measures cable tensional forces placed on said left and right end-effectors.

26. The exoskeleton according to claim 24, wherein a third load cell is mounted within said left load coupler and said right load coupler, said third load cell is interacted directly by the weight of the load, whereby said third load cell measures forces placed directly on said left and right end-effectors.
